(19) United States
(12) Patent Application Publication
(10) Pub. No.: US 2003/0195046 A1
(43) Pub. Date: Oct. 16, 2003

(54) Target shooting scoring and timing system

(76) Inventor: Friedrich Karl John Bartsch, Figtree (AU)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/296,559

(22) PCT Filed: May 24, 2001
(86) PCT No.: PCT/AU01/00615

(30) Foreign Application Priority Data
May 24, 2000 (AU) PQ 7717

(51) Int. Cl. G06F 17/00; A63F 13/00

(52) U.S. Cl. 463/49; 463/36

(57) ABSTRACT

The present invention relates to a target shooting system for use in an event, such as Biathlon. The target shooting system includes shooting components that simulate shots by emitting radiation having a predetermined frequency, and target systems that detect if the radiation impinges on the target. In addition to this, a controller is provided which is capable of communicating with the target systems. The controller is adapted to receive data from the target systems including timing data representing the time taken by each individual in shooting and/or traversing a course, and score data representing the shooting score. From this the controller can determine results of the event. This allows events such as Biathlon to be co-ordinated using target shooting system that integrates the scoring and timing features normally performed by individuals at the events.

### BACKGROUND TO THE INVENTION

The present invention relates to a controller adapted to control a target shooting system for use in an event, such as Biathlon. The controller is adapted to operate with a shooting component, and a target to form an integrated target shooting system that is capable of monitoring the timing of athletes as they participate in the event.

1. Description of the Prior Art

Sporting events that require participation in target shooting, such as Biathlon, or the like, typically utilise firearms, such as rifles or pistols to shoot a target.

However, this form of event is generally difficult to organise and run due the safety requirements surrounding the use of firearms. In particular, the event needs to be held in a closed environment to prevent stray bullets injuring spectators and competitors. Furthermore, in some countries such as the UK, firearms are illegal, and it is therefore impossible to train or hold such an event in these countries.

A number of optical shooting systems have previously been proposed. However, many of these are either unable to operate during normal daylight conditions, or utilise a laser which is powerful enough to damage the naked eye. Accordingly, neither of these type of system is suitable for use in Biathlon events, which require a system that will operate safely during daylight hours.

Furthermore, as Biathlon is a skill testing event, it is important to ensure that the optical shooting system is able to simulate operation of a firearm, which is not currently achieved by prior art systems.

2. Summary of the Present Invention

In a first broad form the present invention provides, a controller adapted to control a target shooting system for use in an event, the target shooting system including shooting components adapted to simulate shots by emitting radiation having a predetermined frequency, and one or more target systems, each target system being adapted to determine a hit if the radiation impinges on the detector, and determine score data based on the number of bits for a predetermined number of shots, the controller including:

a) A communications port for communicating with the target system(s) via a communications network;

b) A display;

c) A processor, the processor being adapted to:

i) Receive identity data representing the identity of individuals competing in the event;

ii) Receive timing data representing the time taken by each individual in shooting and/or traversing a course including one or more circuits. p2 iii) Obtain at least the score data from the targets,

iv) Determine results of the event based on the score data, the timing data and the identity data; and,

v) Display the results on the display;

The processor can be further adapted to generate a starting sequence, the starting sequence being used by the user to start the event. This can be arranged to cause the individuals to start the event in a particular sequence for example, thereby aiding the co-ordination of the event.

The controller usually further includes an input for manually inputting data. This allows a user, such as an event manager, to enter additional data into the controller. This data can be used by the controller to achieve additional functions.

Thus, for example, the processor can be adapted to operate in a manual mode in which the identity data and the timing data is received via the input.

Furthermore, when the controller is coupled to more than one target system, the processor can be adapted to receive target data via the input, the target data representing the target system used by each individual. This allows the processor to determine the results based on the target data.

However, alternatively, the controller can be coupled to a number of sensors for detecting the individuals as they shoot or traverse the course. In this case, the processor is preferably adapted to receive the identity data and the timing data via the sensors.

This allows the system to automatically determine shooting scores as well as timing results for the individuals competing in the event. The sensors can be positioned in any location. However, typically at least one sensor is associated with each target system to allow the presence of an individual to be detected as the individual shoots.

Accordingly, when controller is coupled to more than one target system a respective sensor is associated with each target system, the processor being further adapted to receive target data representing the target system used by each individual, the processor being adapted to determine the result based on the target data.

In addition to this, sensors may be positioned on for example, the main loop or a penalty loop of a course the individuals must traverse, as well as on any start or finish lines.

In this case each individual is preferably associated with an identifier having an identifier store storing the identity data for the individual, the sensors being adapted to communicate wirelessly with the identifier to obtain the identity data. The identifier may be in the form of a tag that is coupled to the individual, or it may form part of a respective shooting component.

Optionally event data indicating a number of laps is received via the input, with the score data indicating the number of hits and misses by each individual. In this case, the processor can be further adapted to generate an event sequence for controlling the event in accordance with the event data and the score data. This may include indications of penalty laps to be completed by individuals, for example.

In a second broad form, the present invention provides a computer program product adapted to control a target shooting system for use in an event, the target shooting system including shooting components adapted to simulate shots by emitting radiation having a predetermined frequency, and one or more target systems, each target system being adapted to determine a hit if the radiation impinges on the detector, and determine score data based on the number of hits for a predetermined number of shots, the computer program product including computer executable code which when run on a processor causes the processor to:

a) Receive identity data representing the identity of individuals competing in the event;

b) Receive timing data representing the time taken by each individual in shooting and/or traversing a course including one or more circuits.

c) Obtain at least the score data from the target,

d) Determine results of the event based on the score data, the timing data and identity data; and,

e) Display the results on the display;

The computer program is adapted to cause the processor to operate in accordance with the controller operation outlined above with respect to the first broad form of the invention.

In a third broad form, the present invention provides a shooting component for use in a target shooting system, the target shooting system including at least one target for detecting radiation emitted by the shooting component, the shooting component including:

a) A housing;

b) A trigger mounted to the housing;

c) A radiation source for generating collimated radiation having a predetermined frequency;

d) A store for storing shot data indicating a number of shots available;

e) A processing system couples to the trigger, the processing system being adapted to:

i) Determine the number of shots available from the shot data;

ii) If one or more shots are available, monitor the trigger;

iii) In response to operation of the trigger, cause the radiation source to generate at least a pulse of radiation; and

iv) Modify the shot data to reduce the number of shots available.

Accordingly, the present invention provides a shooting component which when utilised with an appropriate target can be used to simulate target shooting.

Preferably the radiation source is adapted to generate visible radiation. This allows the user of the shooting component to observe the location at which the shot impinges on the target, thereby allowing the shooter to monitor their accuracy at hitting the target.

Typically the shooting component further includes a trigger detector, the trigger detector being mounted to the housing to detect movement of the trigger and the processing system being coupled to the trigger detector to detect operation of the trigger.

Optionally the shooting component may further include an action mounted to the housing to simulate the loading of a firearm, the processing system being further adapted to:

i) If one or more shots are available, monitor the action; and,

ii) In response to operation of the action, monitor the trigger.

In this case, the action may be provided in a similar form to the trigger, thereby allowing inexperienced users to operate the shooting component successfully in a manual loading mode. The action is not required however, if the shooting component is to utilise semi-automatic or fully automatic operation.

If an action is included, the shooting component usually includes an action detector, the action detector being mounted to the housing to detect movement of the action and the processing system being coupled to the action detector to detect operation of the action.

The housing usually includes:

a) A stock adapted to be held by the user in use, the trigger being coupled to the stock;

b) A tubular barrel defining a barrel axis, the barrel having a first end mounted to the stock, the radiation source being mounted in the first end of the barrel so as to emit radiation pulses from a second end of the barrel in a direction substantially parallel to the barrel axis;

c) Sights mounted to the barrel to align the barrel with the target; and,

d) A chassis coupled to the stock, the controller being mounted on the chassis

Typically the stock is modelled on a firearm, such as a rifle, pistol, or the like, and therefore usually includes:

a) A cheek piece;

b) A butt piece;

c) A fore hand grip; and,

d) A trigger grip.

The store is typically adapted to store identity data, the identity data representing the respective shooting component or the individual using the shooting component, the shooting component being adapted to transmit the identity data to the target.

In this case, the processing system is generally adapted to pulse modulate the radiation in accordance with the identity data, thereby transmitting the identity data to the target. However, other forms of modulation, such as amplitude or frequency modulation could be used.

The shooting component may also include a display coupled to the processing system, the display being adapted to display the shot data.

Preferably the shooting component further includes a magazine adapted to couple to the housing in use, the magazine including the store and a connector for coupling the store to the pulse controller. This allows the identity of individuals to be associated with respective magazines, thereby allowing the individuals to be uniquely identified.

Preferably the shooting component includes a second radiation source coupled to the processing system, the second radiation source being adapted to generate divergent radiation having a second predetermined frequency, the target being adapted to detect the divergent radiation to determine when a shot has been fired.

Divergent radiation will be detectable over a larger area than the collimated radiation, which can be used to ensure that the divergent radiation is detected each time the shooting component is fired, even if the collimated radiation misses the intended target and is therefore not detected. Accordingly, this can be used to detect when a shot misses the target.

The second radiation source typically generates non-visible radiation.

The processing system is typically adapted to pulse modulate the divergent radiation in accordance with the identity data, thereby transmitting the identity data to the target. In this case the collimated radiation need not be pulse modulated.

In a fourth broad form the present invention provides a target system for use in a target shooting system, the target shooting system including a shooting component adapted to simulate shots by emitting of radiation having a predetermined frequency, the target including:

a) A target housing;

b) One or more targets, each target including at least one detector;

c) One or more filters for filtering radiation impinging on each detector, each filter being adapted to transmit radiation having the predetermined frequency and each filter including:

i) A geometrical filter; and,

ii) An optical filter; and,

d) A detection system adapted to:

i) Determine a hit to occur by detecting radiation impinging on a detector; and,

ii) Determine a score based on the number of hits for a predetermined number of shots.

Each geometrical filter preferably includes a cavity, the cavity having an aperture defining an aperture plane mounted at a first end of the cavity, the detector being mounted at a second opposing end of the cavity such that only radiation entering the aperture substantially perpendicular to the plane impinges on the detector.

Typically the inner surface of the cavity being coated with a radiation absorbing surface.

As a further development, the cavity can include a number of tubes, each of which extends from the aperture to the detector, the inner surface of each tube being coated with a radiation absorbing surface.

Alternatively, instead of tubes, the cavity can include a number of micro louvres extending from the aperture to the detector.

The optical filter usually includes a band pass filter, the band pass filter being adapted to transmit radiation having the predetermined frequency.

When the shooting component is adapted to pulse modulate the radiation in accordance with identity data, the identity data representing the respective shooting component or the individual using the shooting component, the detection system is typically adapted to detect the pulse modulation of the radiation to determine the identity data.

If the shooting component is adapted to generate divergent radiation, the target system usually includes at least one second detector coupled to the detection system, the second detector being positioned remotely to the target housing to allow the detection system to detect the divergent radiation to determine when a shot has been fired.

If the shooting component being adapted to pulse modulate the divergent radiation in accordance with identity data, the identity data representing the respective shooting component or the individual using the shooting component, the detection system is preferably adapted to detect the pulse modulation of the divergent radiation to determine the identity data.

In this case, the second detector usually detects non-visible radiation.

Typically at least one detector is divided into a number of zones, the detection system being adapted to determine a score in use, the score indicating the number of times the radiation has impinged on different detector zones, each zone being assigned a respective score.

The target system usually includes a target display, the target display being adapted to display an indication of the current score in use.

In a fifth broad form the present invention provides a target shooting system adapted for use in an event, including:

a) One or more shooting components adapted to simulated shots by emitting radiation having a predetermined frequency;

b) One or more target systems, each target system being adapted to determine a hit if the radiation impinges on a detector, and determine score data based on the number of hits for a predetermined number of shots; and,

c) A communications network; and,

d) A controller adapted to:

i) Receive identity data representing the identity of individuals competing in the event;

ii) Receive timing data representing the time taken by each individual in shooting and/or traversing a course including one or more circuits.

iii) Obtain at least the score data from the targets; and,

iv) Generate results of the event based on the score data, the timing data and the identity data.

In this case, the controller, the shooting component and the target system are preferably in accordance with the first, third and fourth broad forms of the invention respectively.

The target shooting system usually further includes:

a) An identifier associated with each individual, the identifier including a store for storing the identity data of the individual; and

b) A number of sensors, at least one sensor being associated with each target system, the sensors being adapted to:

i) Detect the individuals as they shoot or traverse the course;

ii) Communicate wirelessly with the identifiers to obtain the identity data; and,

iii) Generate the timing data, the timing data being transferred to the controller.

Furthermore, each second detector of the target systems is usually associated with a respective sensor of the controller, with the sensor and the second detector being positioned remotely to the target housing near the shooting component in use. This sometimes referred to as the monitor timing component which is a sensor system capable of detecting both the presence of an athlete for timing purposes, as well as determining the identity data from the divergent radiation generated by the shooting component.

### BRIEF DESCRIPTION OF THE DRAWINGS

Examples of the present invention will now be described with reference to the accompanying drawings in which:

FIG. 1A is a schematic diagram of a standard target shooting system;

FIG. 1B is a schematic diagram of an enhanced target shooting system;

FIG. 2A is a schematic diagram of a first example of a shooting component of FIGS. 1A and 1B;

FIGS. 2B and 2C are enlarged views of portions of FIG. 2A;

FIG. 2D is a schematic diagram of a second example of a shooting component of FIGS. 1A and 1B;

FIG. 2E is a schematic diagram of the control circuitry of the shooting component of FIGS. 2A to 2D;

FIG. 3A is a schematic diagram of the physical structure of the target system of FIGS. 1A and 1B;

FIG. 3B is a schematic diagram of two joined target systems;

FIG. 3C is a schematic diagram of the control circuitry of the target system of FIG. 3A;

FIG. 4A is a schematic diagram of the reception angle of the target systems;

FIG. 4B is a schematic side view of a hit or miss single cavity detector;

FIG. 4C is a schematic end view of the hit or miss single cavity detector of FIG. 4B;

FIG. 4D is a schematic side view of a precision hit, single cavity detector;

FIG. 4E is a schematic side view of a hit of miss multi tunnel grid detector;

FIG. 4F is a schematic end view of the hit or miss multi tunnel grid detector of FIG. 4E;

FIG. 4G is a schematic side view of a precision hit, multi tunnel grid detector,

FIG. 4H is a schematic side view of a hit or miss multi-louvre grid detector;

FIG. 4I is a schematic end view of the hit or miss multi-louvre grid detector of FIG. 4H;

FIG. 4J is a schematic end view of the hit or miss multi-louvre grid detector;

FIGS. 5A to 5D are examples of target configurations;

FIGS. 6A to 6F are examples of detector configurations;

FIG. 7 is a schematic diagram of the controller of FIGS. 1A and 1B;

FIG. 8 is a schematic diagram of the monitor timing component of FIG. 1B;

FIG. 9A is a schematic diagram of a networked standard target shooting system;

FIG. 9B is a schematic diagram of a networked enhanced target shooting system;

### DETAILED DESCRIPTION OF THE PREFERRED EMBODIMENTS

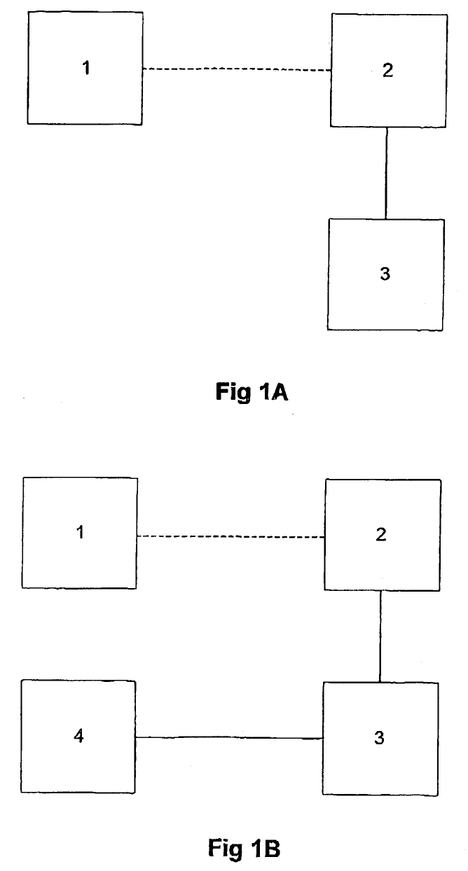

A first example of a target shooting system is shown in FIG. 1A and this will hereinafter be referred to as the standard system configuration. The standard system configuration is designed to provide all the necessary features for the training of individuals or holding of competitions within small clubs at reduced cost.

The standard system configuration includes a shooting component 1, a target system 2 having one or more targets, and optionally a controller 3. These form a shooting and scoring system by firing a radiation beam from the shooting component 1. The radiation beam is detected and scored at the target system 2. Additionally score data recorded at the target system 2 can be gathered by the controller 3.

The system can also be used to provide for the sequence and timing of an event, such as a biathlon to be controlled by a person who is the event manager. In this case, the event manager interaction determines the athlete timing and identification information throughout the event, with this information being input into the controller 3, which uses the information to produce event results.

A second example of a target shooting system is shown in FIG. 1B and this will hereinafter be referred to as the enhanced system configuration. The enhanced system configuration is designed to fulfil every requirement for running large Biathlon competitions with minimal human resources.

It provides all the features of the standard system but also completely integrates an electronic athlete identification and timing system. In this case the system includes an additional monitor timing component 4 which is used to allow the timing of athletes participating in events such as biathlon to monitored automatically. This can include monitoring both the duration of a number of shots using the shooting component, as well as the lap times taken for the athletes to traverse a course.

In the enhanced system the shooting component 1 is adapted to transmit uniquely coded rifle, or competitor data, as well as shooting data. The data and the shots are detected and scored at the target system 2 and then displayed at the firing point by a locally positioned monitor timing component 4 that also detects and identifies the athletes.

All athlete scoring and timing information is detected by the system via the target system 2 and the local monitor timing component 4 and is stored by the controller 3 for subsequent processing, storage, display and printing of results.

The data gathered can include start times, shooting times & scores and finish times for each competitor during each portion of the event. All the necessary information required to produce event results is recorded by the personal computer automatically. A high level of information redundancy is provided by the enhanced configuration to maximise the fault tolerance and reliability of the system.

In addition to this, the controller can generate an extensive set of files, which provide an auditable record of the entire event. This is important for major events such as district, state, national and international competitions.

Operation of Systems and the individual components will now be described in more detail below.

In a shooting and scoring mode of operation, the athlete uses the shooting component 1 to aim at a remotely positioned target system 2. A single transmission beam of highly collimated radiation is emitted from the shooting component 1 towards the target system 2. The pint at which the radiation impinges on detectors in the target system is used to determine a score indicating the alignment accuracy of the shooting component achieved by the competitor. In this case, transmission of data only occurs during hit conditions.

A highly collimated visible beam is used to make calibrating the point of impingement to the sighting geometry very easy to carry out, as well as replicating the process of shooting a solid projectile. The cross sectional diameter of the collimated beam at the target distance is calibrated to be equivalent to the diameter of the projectiles used in the shooting discipline which is being replicated by the electronic system.

An additional second divergent radiation beam can be employed to provide supplementary data transfer to the local monitor timing component 4 positioned near the shooting component. The divergence of the second radiation beam is adjusted for non-precise aiming so that the transmission of data occurs, during both hit and miss conditions on the remote target system. Accordingly, the placement of the monitor timing component 4 is such that it will always be impinged on by the divergent beam if the athlete is aiming at or near the remote target system.

The purpose of the arrangement is to simulate the nature of firing a projectile of fixed size and duration at a target, but at the same time determining whether a hit or miss has resulted, as well as providing information transfer from the shooting component to the target system. The collimated radiation beam impinges on the target system detectors during a hit situation, whilst the divergent radiation beam pulse impinges on the monitor timing component 4 during both hit and miss conditions. Both radiation beams transmit data, but the link via the divergent radiation beam has a much higher probability of success and therefore provides error checking and correction for the remote data transmission link via the collimated beam. The simultaneous transmission of data via both beams provides a very robust and fault tolerant mechanism for detecting and determining the data sent over the remote link where the distances may be considerable, and the environmental conditions may not be ideal such as in the case of bad weather.

In both cases the transmission mechanism of both the radiation beams is such that the beams can be in the form of a fixed pulse or a sequences of coded pulses, encoded on one or both beams.

In a timing and identification mode of operation (only available on the enhanced system), the system utilises another additional system of wireless electromagnetic, multiple signal transmission and reception mechanisms.

In this case, the monitor timing component 4 carries out the task of determining the presence of either or both the athlete and the shooting component 1. The monitor timing component 4 utilises a timing mechanism to determine and record the exact timing and sequence of operations during an event as well as identifying both the athletes and shooting components 1 identification code. This additional task is carried out in conjunction with logging the scoring information from the target system 2.

Operation of each of the different components will now be described in more detail.

The Shooting Component

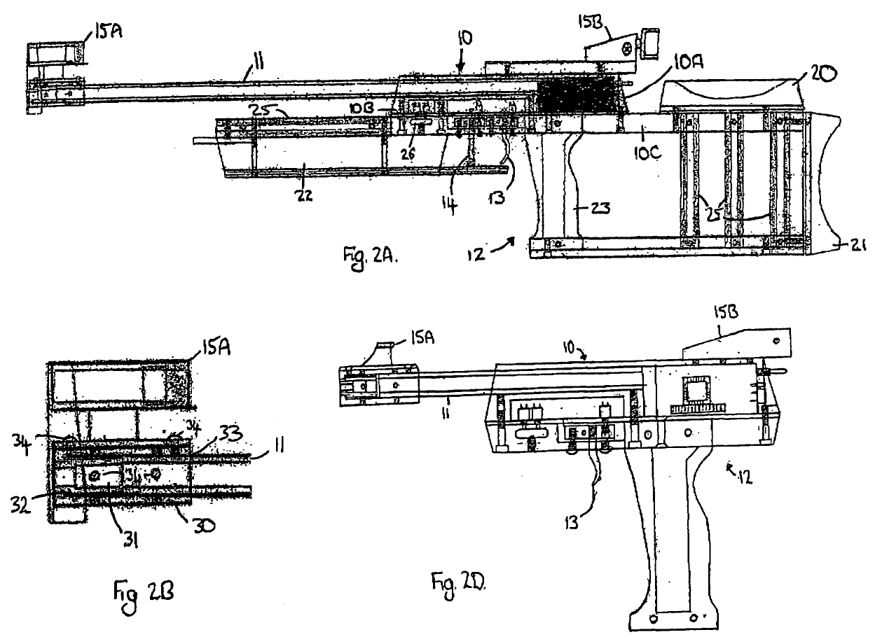

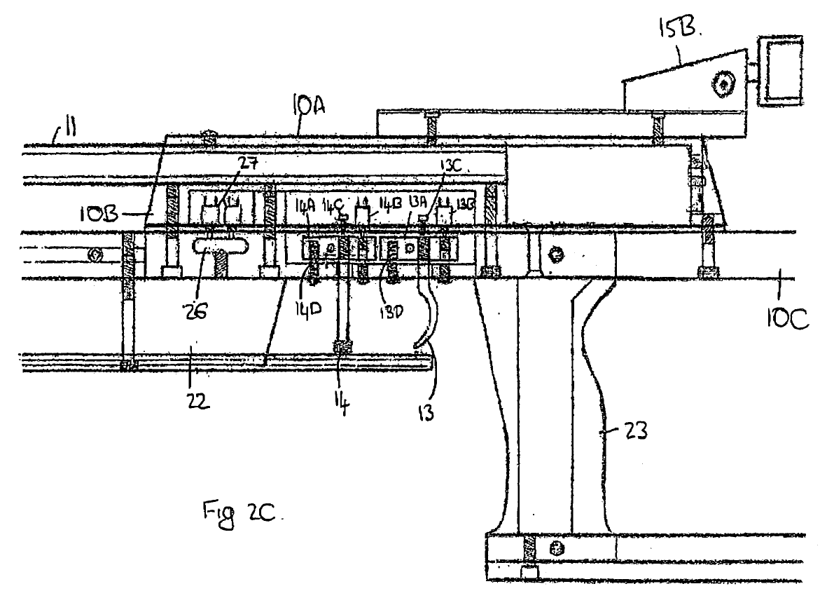

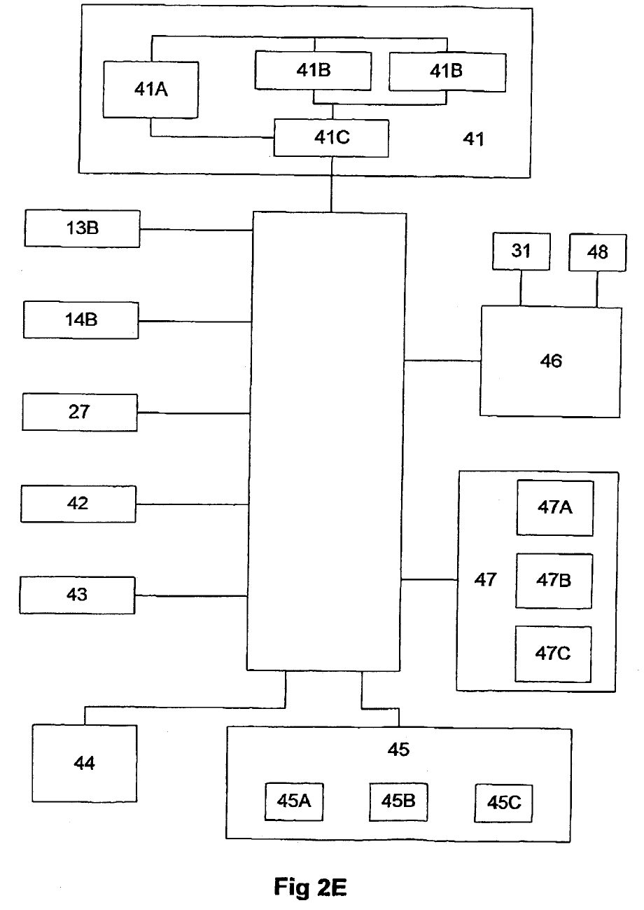

An example of the physical construction of a rifle version of a shooting component is shown in FIG. 2A, with additional details of the sights and the housing being shown in FIGS. 2B and 2C, respectively.

As shown the shooting component includes a barrel 11, a stock 12, a trigger 13 and an action 14, which are coupled to housing 10, as shown. The shooting component also includes sights formed from two sight portions 15A, 15B, which are coupled to the barrel 11. In use a magazine (not shown) is also provided for connecting to the housing as will be explained in more detail below.

A pistol version of the shooting component can also be produced by the use of suitably adapted housing 10 and stock 12, as shown in FIG. 2D. In this example, the pistol does not include a manual action, but rather includes an automatic action (not shown) so that the pistol implements either semi-automatic or fully automatic operation.

The shooting component also includes shooting circuitry that is positioned in the housing 10, to control the generation of the radiation beams. An example of the shooting circuitry is shown as a block diagram in FIG. 2E. As shown, the shooting circuitry includes a processing system 40 formed from a processor 40A and programmable logic 40B. The processing system is coupled to a power supply 41, a mode selector 42, a menu selector 43, an identity tag 44, a number of interfaces 45, signal emission circuitry 46 and a number of indicators 47, coupled together as shown. In addition to this, the processor is also coupled to the action, trigger and magazine sensors 13B, 14B, 27.

Operational sequence flows for the shooting component 1, both pistol and rifle versions, are shown in Appendix A.

The shooting component 1 is designed to perform one or more of the following tasks:

1. Detect the physical interaction of the athlete and the replica firearm when performing the required actions during the aiming and shooting process at a target such as; magazine load, action set, aim and sight target, pull trigger, fire shot, etc.

2. Emit multiple coded/modulated electromagnetic signals each time the athlete shoots at the target system.

3. Perform the same functions as a target shooting device in terms of handling and usage.

4. Indicate to the shooter of component and shooting status.

5. Indicate to the shooter of start up status, incorrect usage and system failures.

6. Provide local visual and audible indication to the athlete of the shooting process and status in real time.

In this example, the shooting component 1 is a purpose built, precision machined and manufactured apparatus that is versatile in assembly so it can meet many of the competition requirements encountered by national and international target shooting organisations.

Thus the electronic rifle shown in FIG. 2A includes the same functional features as rifles used for Biathlon competitions. The rifle is designed to allow customisation by the user to meet both, individual user and competition regulation requirements. The electronic rifle or pistol is easily adapted for right hand or left hand operation, since the design is fully symmetrical.

Due to the electronic design, a high-speed automatic rate of fire can be easily implemented, however a traditional manual loading action has also been retained in the design to meet the needs of many current shooting competitions. In this example, the rifle does not however, try to simulate the effect of recoil or percussion during firing.

The shooting component 1 is compact and portable, being small enough to be easily relocated by hand and battery powered for use in remote locations. It contains re-programmable processor and programmable logic devices, to provide sophisticated and versatile capabilities. It can also carry out self-diagnostic tests and is designed to be highly reliable under extreme environmental conditions.

The structural design is such that left and right hand users can be easily accommodated due to a 100% symmetrical structure. This includes the choice of a dual sided and profiled cheek piece which suits left and right handed users or a single sided cheek piece which can be rotated 180 degrees to suit. Furthermore all mechanical components can be easily increased or decreased in size to accommodate a large range of user sizes from small young children to large adults.

The function of each of the physical elements of the shooting component will now be described in more detail.

Housing 10

The housing 10 is formed from a unique triple layer design that includes a receiver 10A, a sensor layer 10B and a chassis 10C. In this example, the housing is an aluminium alloy construction that can be scaled in size to suit the requirements of the user. It contains multiple, precision machined cavities and threaded holes, for locating sensors, actuators, electronic circuits, power sources and fastening devices.

In use, the sensor layer 10B provides the means of locating and aligning the electronic sensors with the mechanical actuators, as well as providing physical isolation between the receiver and the chassis.

The receiver 10B contains all the electronic components, hardware and printed circuit board, as well as supporting the collimated beam and aiming apparatus in the form of the barrel 11 and the sights 15.

The chassis 10C contains the mechanical actuators and handling apparatus used by the shooter. The chassis is also designed to accept a number of attachment tacks 25, used for locating and anchoring a carrying shoulder harness and or a shooting arm sling.

The main advantage of this design is that the sensor layer 10B is a relatively simple structure that be easily changed or modified to suit a wide variety of sensor technologies, with out the need to modify the design of the receiver or the chassis.

Barrel 11

The barrel 11 is a stainless steel construction that can be manufactured to any length from 50 mm to 1000 mm to suit any specific shooting requirements. It is precision machined to maintain exact and reliable alignment of the sighting attachments and emission devices. It contains a machined cavity to allow the electrical connection of the emission devices to the shooting circuitry.

The barrel is removable from the receiver to allow different sizes of barrel to be used.

Stock 12

The stock 12 is a unique design consisting of four modular units that provide points of attachment for the user to grip and hold. The four units include a cheek piece 20, butt piece 21, fore hand grip 22 and trigger hand grip 23 each of which is attached to the chassis 10C.

Incorporated into the stock, is attachment locating tracks that allow the fitting of equipment such as harnesses and or slings to accommodate a variety of shooting requirements as well as user requirements.

The cheek piece 20, the butt piece 21, the fore hand grip 22 and the trigger hand grip 23 can be made from natural or synthetic materials, and are independently attached to the chassis 10C, as shown. This allows the horizontal and vertical position of each unit to be adjusted, thereby providing the ability to cutomise the stock to meet any restrictions or regulations, as well as to alter the shape, feel and/or comfort of the rifle for a wide range user sizes and shapes.

The trigger hand grip 23 is designed and contoured to allow a comfortable and secure grip by the user and at the same time provide storage compartment for a dual battery system with 100% redundancy for ultra reliable operation.

Trigger 13 and Action 14

As shown in FIG. 2C, the trigger 13 and the action 14 are coupled to respective actuators 13A, 14A, which are in turn coupled to sensors 13B, 14B. This system allows movement applied by the user to the trigger 13 or the action 14 to be detected by the sensors 13B, 14B respectively, thereby allowing operation of the trigger 13 and the action 14 to be detected.

The length of travel and pull weight of both the trigger 13 and the action 14 are fully adjustable by the adjustment of screws 13C, 14C and springs 13D, 14D. Furthermore, the both single stage or double stage actuation mechanisms can be provided for precise shooting characteristics. The finger contact levers of action and trigger are removable and can be replaced with a variety of designs to suit the user.

Unlike any other design, the action actuator is in front of the trigger and operates like a trigger. This means the functional design of the action and the trigger is the same except they can be adjusted to have different pull pressure. It is also possible to interchange electronically, the function of the trigger and action via processor software if so desired.

Sights 15A, 15B

The sights can be screwed or dovetail attached and can include open, aperture or telescopic styles. The sights are removable to allow different design sights to be installed.

Magazine

The magazine consists of a device containing coded information which may be extracted using contact or non contact means via electrical, magnetic or optical signals devices.

A unique side loading magazine port 26 is provided in the chassis 10C to allow physically and visually easier operation and insertion by the user. The port includes magazine sensors 27 that are designed to detect the presence of the magazine and obtain data therefrom, as will be explained in more detail below.

The magazine can be inserted from either the left or right hand sides maintaining 100% ambidextrous operation to suit any user. This provides many benefits when compared to traditional bottom loading magazine designs.

Collimated Beam Alignment Calibration Control Mechanism

The alignment of the impingement point of the collimated beam with the aiming point of the sights is controlled by a sleeve 30 which provided an adjustable interface between a laser light emitting module 31 and the barrel 11.

The sleeve 30 is precision machined to hold the laser module 31 precisely at one end of the sleeve 32, as shown. The positioning of the other end of the sleeve 33 is controlled by four screws 34 that are threaded into the barrel 11, as shown. These screws 34 work in pairs to control the horizontal and vertical position of the beam with respect to the centre line of the barrel and the sights.

Once the alignment has been corrected, the screws 34 are locked in position and normal adjustment of the sights is used for day to day corrections as with conventional shooting systems.

Shooting Circuitry

The shooting circuitry consists of a processor based system with a number of sensor and actuator options that is re-programmable to allow customisation to suit specific target shooting requirements. The shooting circuitry can utilise a variety of input sensor technologies including electrical, magnetic and optical based devices for determining the state of physical actuators used in the shooting process. Both analogue level and digital state determination of the actuators, can be used depending on the desired precision and operating characteristics required.

In this example, the operation of the shooting circuitry is controlled by applications software executed by the processor 40.

The function of each of the electronic elements of the shooting component will now be described in more detail.

Power Supply 41

The power supply includes regulated and protected power derived from one or more alternative battery sources, providing the capability of redundant power sources.

The power supply can use a single or dual battery 41B configuration to provide power to the entire system. The dual configuration can be utilised to provide a fault tolerant power supply via redundancy and either battery can provide the entire systems energy requirements by itself. The system will be unaffected by the loss or failure of one battery due to automatic switching to the good battery and isolation of the bad battery during fault conditions leaving the system circuitry fully functional.

Furthermore, rechargeable batteries can be used, and the condition of the batteries can be monitored.

The power supply also incorporates an AC input coupled to an AC rectifying circuit and a DC filtering circuit, as shown at 41A. This can be used to provide power to the system in the event of faulty or flat batteries as well as provide energy for recharging batteries using an industry standard battery charging circuit. This is achieved via an industry standard integrated circuit 41C that included characteristics such as low drop out voltage, reverse voltage protection, over current and thermal shutdown protection.

Trigger and Action Sensors 13B, 14B

The action sensor is designed to detect the physical movement that the athlete applies to a mechanical structure of the action during the process of simulating the function of loading the chamber of a firearm with a bullet.

Similarly, the trigger sensor is designed to detect the physical movement that the athlete applies to a mechanical structure during the process of simulating the function of shooting a bullet from a firearm.

The system is designed to accept a signal from a wide variety of sensors to provide a versatile range of choices to both the user and the manufacturer for detecting the position of this mechanical structure called the action.

Sensors which are supported can utilise either electrical, magnetic or optical detection methods and be of either analogue or digital modes of signal type. The action sensor can be configured to only consume energy once a magazine has been detected by the system. This feature allows considerable power savings if more sophisticated analogue sensors are utilised for more sensitive and controllable operation.

If a digital mode sensor is used then the processor circuit is programmed to detect a logic level change to determine the action point features such as contact bounce filtering are handled in software. This mode uses less energy, is simpler to implement but has fixed sensitivity.

If an analogue mode sensor is used then the processor circuit is programmed to continuously convert the analogue signal into a digital number and compare it to a predefined reference number to determine the action point. This mode uses more energy, is more complicated to implement but has greater control and sensitivity and can be customised to suit the user.

Three examples of industry standard devices which can determine the presence and position of a mechanical structure and translate it into an electronic signal carrying information are:

A micro switch or push button which will detect movement of an actuator from the presence of absence of resistive continuity from the physical movement of a solid material. This is a binary state digital signal.

A hall effect sensor to detect the presence or absence of a magnetic field from the physical movement of a ferromagnetic material. This can be a binary state digital signal or a continuously variable analogue signal.

An optical emitter/detector sensor to detect the presence or absence of a light from the physical movement of an opaque material. This can be a binary state digital signal or a continuously variable analogue signal.

Magazine Sensors 27

The magazine sensors are designed to detect the physical movement that the athlete applies to a mechanical structure during the process of simulating the function of inserting a magazine encoded for storing a predetermined number of shots into a firearm. However, because this is not a firearm, the magazine can also be used to up load advanced configuration information into the system that may be required for particular operating conditions during a competition.

Extra information such as shooting sequences, athlete identification numbers, event numbers etc can be loaded via the magazine.

Therefore a number of magazine sensors and types of sensors can be used simultaneously.

The magazine sensors generate an interrupt in the CPU to wake the system from the low power energy saving sleep mode. The system is designed to accept a signal from a wide variety of sensor types to provide a versatile range of choices to both the user and the manufacturer for detecting the position of this mechanical structure called the magazine. The use of more than one sensor can provide a multi function capability where different types of magazines can be used and are coded for different modes of operation. For example different shot capacities and or configuration values can be coded into a magazine and down loaded into the replica firearm when inserted.

Sensors which are supported can utilise either electrical, magnetic or optical detection methods and be of either analogue or digital modes of signal type.

If a digital mode sensor is used then the processor circuit is programmed to detect a logic level change to determine the action point features such as contact bounce filtering are handled in software. This mode uses less energy, is simpler to implement but has fixed sensitivity.

If an analogue mode sensor is used then the processor circuit is programmed to continuously convert the analogue signal into a digital number and compare it to a predefined reference number to determine the action point. This mode uses more energy, is more complicated to implement but has greater control and sensitivity and can be customised to suit the user.

If an intelligent sensor is used, then the processor is programmed to accept information via a bi-directional interface so that complex information can be loaded into the system. This would allow for sophisticated system configuration.

Examples of industry standard devices which can determine the presence and position of a mechanical structure and translate it into an electronic signal carrying information are:

Micro switches or push buttons which will detect movement of an actuator from the presence of absence of resistive continuity from the physical movement of a solid material. This is a binary state digital signal.

Hall effect sensors to detect the presence of absence of a magnetic field from the physical movement of a ferromagnetic material. This can be a binary state digital signal or a continuously variable analogue signal.

Optical emitter/detector sensors to detect the presence or absence of a light from the physical movement of an opaque material. This can be a binary state digital signal or a continuously variable analogue signal.

Magnetic stripe reader to transfer sophisticated configuration and usage data to and from the shooting component 1 using industry standard magnetic stripe technology.

Smart card reader to transfer sophisticated configuration and usage data to and from the shooting component 1 using industry standard smart card technology.

Indication Circuitry 47

The indication circuitry includes audible and visual indicators 47A, 47B as well as a visual multi-character alphanumeric liquid crystal display 47C.

Audible Indicator 47A

This section provides the ability the control the volume and type of audible indication from an audio transducer which maybe an industry standard device of electromagnetic or piezoelectric design.

Audible indication is used to indicate many different conditions for either operational and or status situations, often simultaneously with the visual indicators. Status conditions usually pertain to situation to alert the user to particular condition such as the state of batteries, internal references, temperatures etc and whether they meet or exceed acceptable limits. These usually occur during start up or system test modes of operation. Operational conditions include indication of successful normal run functions such as magazine loading, cocking the action and pulling the trigger.

Parameters that can be controlled include power, frequency, duration and coding delivered to the audio indication device.

Volume levels can be adjusted for different volume levels to suit the user. The volume can be set to zero if no audible indication is required. The tone, duration and coding of the audible indication for each function is processor controlled.

Visual Indicator 47B

The visual indicator provides a controlled colour and type of visual indication from optical transducers that are industry standard devices such as high efficiency, low current, light emitting diodes.

Visual indication is used to indicate many different conditions for either operational and status situations, as described above with respect to the audible indicator.

Parameters that can be controlled are power, wavelength, duration and coding delivered to the visual indication devices. The wavelength, duration and coding of the visual indication for each function is processor controlled.

Alphanumeric Liquid Crystal Display 47C

The LCD provides an enhanced form of information display if required by the user. An industry standard LCD module interface is used to interchange data to and from the processor.

All information coded through the audible and visual indicators can be conveyed via the LCD in a graphical or alphanumeric, user friendly manner. Additional information can also be displayed on the LCD such as actual values for parameters such as battery and reference voltages, temperatures, time delays, magazine capacities, action and trigger set points etc. Any information desired about the system can be programmed via the processor to be viewed on the LCD.

Typical Use of Indicators

Green Indicator Off No shots left or loaded.

Green Indicator Flashing No shots remaining but magazine still in Rifle.

Green Indicator On Shots are loaded and ready to fire.

Red Indicator Off No shot is being fired the laser is off.

Red Indicator On A shot is being fired and the laser is on.

Audible Indicator Off No shot is being fired the laser is off.

Audible Indicator On A shot is being fired and the laser is on.

One Beep and Green Flash One shot has been loaded

Two Beeps and Green Flashes Five shots have been loaded

Three Beeps and Red Flashed Magazine is empty and no shots are left.

Five Short Beeps and Red Flashes Low Battery Voltages or other alarm conditions.

Mode Selector 42

The mode selector is designed to allow the system to function in a number of different modes of operation. The selector simply determines the state of a sensor. This feature provides a simple way of entering a particular mode such as Calibration or Competition mode by monitoring the sensor status from the processor software. This feature is can also be carried out by the menu/select sensors and LCD if they are installed. The sensors typically consist of industry standard micro switches or micro push buttons.

Menu/Select Sensors 43

The menu and select sensors are an enhanced feature that provides the user with the ability to interrupt the processor's operation and run a function menu selection procedure to alter or customise the system configuration. Each time the menu sensor is actuated, the user is incremented through a list of functions that can be viewed on the LCD. When the desired function has been reached, the select sensor is actuated and that feature is altered as required, or a new list is displayed and the process continues. This enhancement requires the LCD to function correctly. Typical configuration parameters include network address, bullet delay, indicator delay, indicator options, baud rate, detector arrangement etc.

The sensors typically consist of industry standard micro switches or micro push buttons.

In this particular case the sensors can consists either a pair of push buttons or a three position centre return toggle switch which enables the user to access a detailed list of menu options and select the desired function.

Signal Emission Circuitry 46

The signal emission circuitry consists of power controlled, driver circuits, modulation control circuits and electromagnetic radiation emission devices, which in this case, includes the laser light emitting module 31 and a divergent beam emitter 48. This circuitry is capable of emitting, fixed or coded pulse signals to one or more emission devices, to suit the desired requirements and level of sophistication.

Laser Module 31

The purpose of the collimated beam is to transmit a signal from the shooting component to the target system 2 so as to form a shooting network connection.

The collimated beam is composed of a visible electromagnetic signal, emitted from a coherent light emitting device such as a laser module 31. The laser device utilises an industry standard, semiconductor laser diode and photo diode technology with an integral single or multi-segment lens design for providing the desired beam collimation characteristics. Fixed or adjustable focus lens designs manufactured from plastic or glass can be used depending on the shooting distances and precision required to the remote target system.

The laser diode is energised by an automatic power control circuit which stabilises the laser diode threshold current via a feedback circuit from the integral photo diode which sensors the optical output power of the laser diode. This provides an automatic optical power output control mechanism during steady state operation.

In addition to this, a modulation circuit is used to code a signal onto a carrier frequency that is superimposed onto the threshold current of the laser diode. The result is a coded and modulator optical signal that is electronically controlled by the processor and can be detected remotely by a suitable target system.

Generally, any visible wavelength can be used, provided the corresponding detection system at the target system is designed to match. There are significant advantages to using a wavelength that is highly visible to the human eye for the purpose of making it easy to calibrate the collimated beam with the sighting geometry of the replica firearm. However it is important when using visible laser beams, that the relevant laser safety standards are met under all conditions.

Generally the use of short coded pulse signals of the order of 10 milliseconds or less and continuous optical output powers of 1 millwatt or less are deemed to be safe under normal conditions. These would typically be classified as Class II laser devices that are used commonly world wide for a variety of unrestricted applications.

Invisible Divergent Beam Emitter 48

The purpose of the divergent beam is to transmit a signal from the emitter to a detector in a local monitor and form a monitoring network connection.

Any wireless data transmission technology can be used provided it exhibits a transmission pattern which can be controlled to ensure that the local monitor timing component 4 will receive the signal during normal hit and miss conditions at the remote target system. At the same time however, adjacent monitors should not receive unwanted signals. Therefore any electromagnetic, optical or ultrasonic signals can be used.

Thus, for example, the divergent beam can be composed of an invisible electromagnetic signal, emitted from a coherent of non-coherent light emitting device module. Thus for example an industry standard laser similar to that describe above with respect to the Laser module 31 could be used with the laser being configured to generate a divergent, rather than a collimated beam.

Computer Interfaces 45

The computer interface includes SPI, RS232 and IRDA interface connections allowing half or full duplex data transfer to and from standard computers systems. This provides a means of extracting data from the system and or inserting data into the system, in order to read or modify system settings. The system can also be completely reprogrammed to provide new firmware upgrades as required.

RS232/IRDA Interfaces 45A

An industry standard asynchronous serial interface using RS232 and IRDA standards and interface devices is provided for general communication with external devices such as the controller.

SPI/I2C Interfaces 45B

An industry standard synchronous serial interface using SPI and I2C standard and interface devices is provided for general communication with internal devices such as digital displays, card readers etc and input output expansion. These allow enhanced configurations options to be provided which only require software updates to the processor.

JTAG & ISP Interface 45C

JTAG is an industry standard, in circuit device programming and boundary scan interface for complex, large scale, highly integrated semiconductor devices. ISP is a proprietary in circuit serial programming interface for many industry standard embedded processor integrated circuits. Both of these interfaces are built into the system to allow for in circuit programming, testing and upgrading of the embedded system configurations and software.

Processor 40A

An industry standard processor (CPU) is used to perform all data processing requirements that the system needs to perform while interfacing with any input output devices used in the shooting component 1. Major benefits are gained in printed circuit board design, flexibility and assembly by using high level integration technology.

In this example, the processor is a high-performance multi-function FLASH micro-controller that provides the highest design flexibility possible. The design includes a reduced instruction set and Harvard architecture. This design of less than 1 microsecond per instruction whilst an internal power saving sleep mode delivers a stand by power that is less than 50 microamperes. Main attributes of the device architect and internal design are to achieve low power and high-speed characteristics.

In addition to FLASH program memory, Electrically Erasable data memory and user random access memory (RAM), the processor also features an integrated multi channel multi bit Analog-to-Digital converter (ADC) and multiple Analogue Comparators. Peripherals include multiple 8-bit and 16-bit timers, a Watchdog Timer, Brown-out Reset (BOR), In-Circuit Serial Programming™ (ISP), RS-485 type UART for multi-drop data acquisition applications and I2C™ or SPI™ communications capability for peripheral expansion. Precision timing interfaces are accommodated through multiple Capture Compare and Pulse Width Modulation modules. The processor also support low voltage self-programming, allowing the user to program the device in-circuit at the user's operating voltage.

Programmable Logic 40B

An industry standard Complex Programmable Logic Array Device (CPLD) is provided to perform any additional glue logic requirements that the processor needs to interface with any input output devices used in the shooting component 1. This eliminates the need form any additional digital devices, reducing the digital integrated circuit down to two devices only. Major benefits are gained in printed circuit board design, flexibility and assembly by using high level integration technology.

The CPLD architecture consists of multiple logic blocks each containing multiple macro cells, a PAL array, a PLA array and control terms. Each logic block is connected through a connection array providing multiple inter-connection and feedback paths. It is specifically optimised for low power operation in applications that include portable, handheld, and power sensitive systems. Main attributes of the device and internal design are to achieve low power and high speed characteristics. The internal design offers pin-to-pin speeds of less than 10 nanoseconds, while simultaneously delivering power that is less than 100 microamperes in stand by, without requiring special external power down control that can negatively affect device performance.

Other architectural features include a direct input register path, multiple clocks. JTAG programming, multi volt tolerant I/Os. These enhancements deliver high speed coupled with the best flexible logic allocation which results in the ability to make design changes without changing pin-outs This combination allows logic to be allocated efficiently throughout the logic block and support as many product terms as needed per macro cell. In addition, there is no speed penalty for using a variable number of product terms per macro cell.

RF Identification Tag 44

The purpose of the identification tag is to transmit a signal and data to and from the emitter equipment to an interrogator in a local monitor and form a scanning network connection.

An industry standard, contactless/wireless, read/write passive Radio Frequency Identification Device (RFID) that is optimised for electromagnetic radio frequency carrier signal is used for athlete and equipment identification. The tags can be attached to the athlete via a wrist or ankle strap and be used in the passive mode whereby no power supply is required, but instead derive their energy from the wireless transfer of energy from the interrogator. They can also be attached to or embedded in the emitter shooting component housing.

Those that are attached will function in the passive mode, alternatively the embedded tags can be used in either the passive or active mode. The active mode uses the power source already available in the emitter shooting component.

These tags provide a flexible but accurate method of tracking the location and timing of each competitor or their shooting equipment in a event and or at multiple locations throughout the event such as shooting lanes, start & finish lines or even the start & finish of main loops and penalty loops.

The device can use an external inductor capacitor resonant circuit to wirelessly communicate with the monitor timing component and its identification tag interrogator. The device is powered remotely by rectifying a RF signal that is transmitted from the interrogator, and transmits or updates its memory contents based on commands from the interrogator. The tag is engineered to be used effectively for athlete, competitor or equipment tagging applications. Particularly in situations where there is a significant overhead in management of results for major events, where a large volume of tags maybe read and written in the same interrogator field or multiple geographically dispersed interrogator fields are required.

The identification tag technology contains multiple blocks of electrically erasable, programmable memory EEPROM. Each block consists of 32 bits. This means a variety of options are available from simply storing only the bib number of the athlete to the storing entire detailed information set for each competitor and or the event structure. Alternatively a shooting equipment number, plus all the configuration details can be stored in the shooting equipment's tag. This may include shooting session attributes such as the number of shots and activity loops as well as athlete details such as bib number, name, gender, class, club, grade etc.

The tag also includes a unique anti-collision algorithm to be read or written effectively in multiple tag environments. To minimise data collisions, the algorithm utilises time division multiplexing of the device response so each device communicates with the interrogator in a different time slot.

The Target System

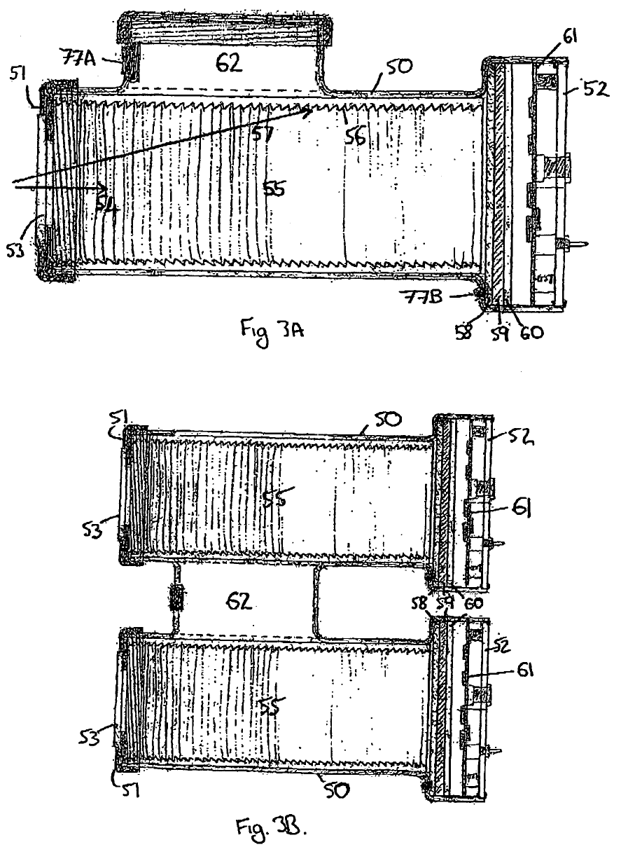

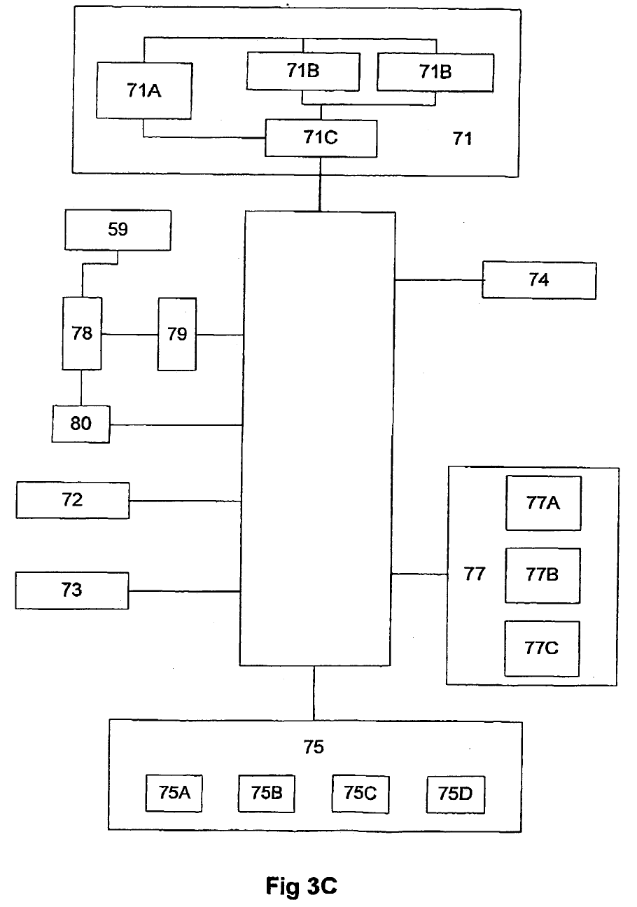

An example of a basic target system is shown in FIG. 3A. In this example, the target system includes a housing 50, which is sealed at either end by the end caps 51, 52. As shown the end cap 51 includes an aperture 53 to allow radiation travelling in the direction of the arrow 54 to pass through the end cap into a cavity 55, as shown.

The surface 56 of the cavity 55, is coated with a radiation absorbing surface, which in this example is ribbed to absorb any radiation which enters the cavity 55 at angle to the aperture 53, as shown by the arrow 57.

Mounted at the opposing end of the cavity 55, away from the aperture 52 is an optical filter 58, a detector 59 and an optical trap 60. Signal detection and scoring circuitry 61 is then mounted between the optical trap 60 and the end cap 52, as shown. Finally a battery compartment 62 is provided, together with an audio and visual indicators 77A, 77B.

As shown in FIG. 3B, it is possible to couple the targets together to form a target system have multiple targets as will be explained in more detail below.

The signal detection and scoring circuitry is shown in block diagram form in FIG. 3C. As shown the control system includes a processing system 70 formed from a processor 70A and programmable logic 70B. The processing system is coupled to a power supply 71, a mode selector 72, a menu selector 73, a video signal processor 74, a number of interfaces 75, and a number of indicators 77, as shown.

In addition to this, the processor is also coupled to the detector 59, via a band pass filter 78, a demodulator 79 and a multiplexer array 80.

The target system 2 is designed to perform at least one of the following tasks:

1. Detect all coded/modulated hit signals on all targets and zones which have been emitted from shooting component.

2. Reject all ambient and none coded/modulated signals impinging on the target which did not originate from the shooting component 1.

3. Demodulate and decode received signals from shooting component 1.

4. Determine which Target and Zones detectors have been successfully impinged.

5. Analyse and score all successfully demodulated and decoded signals and calculate shooting statistics.

6. Transmit shooting statistics data back to the data acquisition and control software.

7. Receive control functions such as reset scores etc from data acquisition and control software.

8. Provide remote visual and audible indication to the athlete of their shooting statistics in real time.

The target system 2 consists of precision machined and manufactured apparatus that is versatile in assembly so it can meet many of the competition requirements encountered by national and international target shooting organisations.

This electronic target system offers the same functional features as encountered in competitions and is achieved by using the following functional components.

By altering the detector arrangement, it can be configured in a number of operating modes. These include, a single hit or miss targets, multiple hit miss targets, or scored hit targets using a row column matrix or concentric rings of multiple detectors.

During all modes of operation, both the steady state and transient parameters of the received signals are detected, analysed, processed and stored. The target system is compact and portable, being small enough to be easily relocated by hand and battery powered for use in remote locations. In this example, it contains re-programmable processor and complex programmable logic devices, to provide sophisticated and versatile capabilities. It can also carry out self-diagnostic tests and is designed to be highly reliable under extreme environmental conditions.

Each of the components and its operation will now be described in more detail below. The overall operation of the system is completely controlled by applications software executed by the processor, as will be described in more detail below.

Housing 50

The housing 50 can be constructed in two different formats to suit the intended application. Single and dual target detector systems are constructed from high impact, waterproof PVC, Poly Carbonate and Aluminium Alloy housing and contains a series of optical filters and optical blocking devices. Multiple target detector systems are constructed from a combined Aluminium Alloy, Polycarbonate and PVC construction, capable of containing up to 20 target detectors at a time. Target housings are sealed against the environment to protect the internal electronic circuitry, detectors and other components.

Signal Detection and Scoring Circuitry

The signal detection circuitry includes multiple stages of analogue processing including amplification, attenuation, filtering and level detection. Decoding, encoding and multiplexing of signals is carried out before presenting data to the processor interface.

The scoring circuitry is formed from the processor and the complex programmable logic device, based system with a number of sensor and actuator options that is reprogrammable to allow customisation to suit specific target shooting requirements. It is capable of scoring from a number of detectors simultaneously. The detector configuration can be single or multiple separate detectors for determining hit or miss on single or multiple targets. Alternatively it is capable of scoring from a matrix of multiple detectors acting as a single target for determining the scored value of a hit on a single target. The scoring circuitry simultaneously measures the raw data from the detectors and the processed data from the signal detection circuitry in order to uniquely analyse and characterise the received information for processing into scored results.

Power Supply 71

The power supply includes regulated and protected power derived from one or more alternative battery sources, providing the capability of redundant power sources.

The power supply 71 is similar to the power supply 41 of the shooting component and therefore will not be described in any further detail.

Indication Circuitry 77

The indicator circuitry includes audible piezoelectric and electromagnetic transducers 77A, visual light emitting diodes 77B and visual multi-character alpha numeric liquid crystal display 77C. The indicators used are similar to those used by the shooting component 1 and accordingly, will not be described in detail.

In this case however, operational conditions include indication of successful normal run functions such as detecting that a target or zone has been successfully impinged on by a shooter.

Computer Interfaces 75

The target system uses interfaces including SPI, RS232, RS485 and IRDA interface connections 75A, 75B, 75C similar to the interfaces 45A, 45B, 45C described above with respect to the shooting component. These interfaces will therefore not be described in any further detail.

In addition to this, an Ethernet, USB, WorldFIP & CAN Network Interface 75D is used to allow multiple target systems to be connected to a single controller for supervisory data acquisition and control. The purpose of the interface 75D is to provide high performance networking for large systems involving large numbers of competitors. This networking procedure will be described in more detail below.

Mode and Menu/Select Sensors 72, 73

The mode sensor 72 and the menu and select sensors 73 operate as described above with respect to the shooting component and will therefore not be described in any further detail.

Processor 70A

The processor is an industry standard Processor (CPU) is used to perform all data processing requirements that the system needs to perform while interfacing with any input output devices used in the shooting component 1. Accordingly, the processor 70A is similar to the processor 40A described above with respect to the shooting component 1 and this will therefore not be discussed in any further detail.

Complex Programmable Logic 70B

An industry standard Complex Programmable Logic Array Device (CPLD) is provided to perform any additional glue logic requirements that the processor needs to interface with any input output devices used in the target system. Again, the CPLD is similar to the CPLD used in the shooting component and this will therefore not be discussed in any further detail.

Detectors 59

A variety of detector types can be used and include the following:

a) Hit & Miss targets consists of a single, large area, optoelectronic based detector.

b) Graded Hit targets, consists of multiple, small area optoelectronic based detectors arranged in concentric ring or square detectors zones.

c) Precision Scoring targets, consists of a matrix of multiple, small area optoelectronic based detectors in a high resolution row column format.

The Hit of Miss mode typically uses only one single silicon based optoelectronic detector for the target. The size of the detector area must be equal to or preferably larger than the desired target size. In the case where the detector size exceeds the target size, an opaque mask is placed in front of the detector to control the viewing and exposed region to impinge from the optical shooting signal.

The Graded Hit mode uses an array of silicon based detectors that form a series concentric rings or squares, much like a typical bullseye target. A series of electronic processing stages are required for each rings, since each ring is a separate independent detector. A single target with up to ten or even sixteen concentric ring detectors can be supported by the standard configuration of electronic processing circuitry. Detectors of this configuration are not standard and have to be especially manufactured.

The Precision Scoring mode uses a matrix of many smaller optoelectronic based detectors, configured in a matrix of rows and columns to provide high resolution scoring capabilities. The detector type requires and extra video processing stage, uses much more power and much higher sampling rates and are available only in a fixed number of small sizes. However they are able to provide precise location of each hit which impinges on the detector.

Video Camera Detector

Consists of a high-resolution charge coupled detector CCD device and an integral lens system. Typical industry standard cameras used in closed circuit television video CCTV security and surveillance systems can be used in conjunction with an intermediate translucent target plate to from a detector. An industry standard CCD consists of several hundred rows and columns of optical sensors while the CCTV circuitry provides a standard synchronous video output signal.

An additional video signal processor 74 is required to convert the synchronous video signal into a rectangular co-ordinate or polar co-ordinate signal. The video signal processor accepts the output from an industry standard video camera and decodes the synchronous signal using level detection and timing detection into data which represents the beam impingement position in either Rectangular Co-ordinates or Polar Co-ordinates. This process uses industry standard, high-speed analogue to digital conversion and processor circuitry.

This type of sensor is used for precise scoring applications and or calibrating and checking the optical beam impingement pattern emitted from the shooting components.

Silicon Optoelectronic Detector

Consists of an industry standard, silicon photo-sensitive detector which converts photons into electrons.

Multi Zone Silicon Optoelectronic Detector

Consists of an especially manufactured, silicon based, photo sensitive device which has a number of electrically isolated detector zones, each which converts photons into electrons. The detector zones each act as separate individual detectors but are physically located on the same substrate panel.

The shape of the zones is dependent on the target shooting application required and any regular geometric or random irregular shape is possible. Some examples of common shapes are given in the target configuration section.

Optical Detector Array

A number of different detector technologies can be utilised depending on what type of target. shooting discipline is required. Some target shooting disciplines only require hit or miss detection, whilst others require accurate position scoring when a hit is detected. In order to meet these different requirements, a number of different detector technologies and configurations are supported.

Preamplifier Array 59

The preamplifier array is used to amplify the very small signals received by the detectors to a level which will allow further processing by subsequent stages and minimise loading on the detectors by the following processing stages. Industry standard, low power, high gain operational amplifiers are used to carry out this task.

Band Pass Filter and Gain Control Array 78

The band pass filter array is used to reject all unwanted out of band signals whilst accepting and flier amplifying wanted in band signals with the desired modulation and carrier attributes. Preferably the filter characteristics perfectly match those of the emitter signal characteristics. Industry standard, low power, high gain, multi stage operational amplifiers, configured as a multi order band pass filters are used to carry out this task.

The gain control array is used to amplify the analogue signals received in preparation for further processing by the multiplexer and ADC in subsequent stages. Industry standard, low power, high gain operational amplifiers are used to carry out this task.

Demodulation and Level Detector Array 79

The demodulation array is used to extract the modulated signal from the carrier signal so that data an be decoded by the CPLD and CPU. Industry standard, low power, high gain operational amplifiers are used to carry out this task.

The level detecting comparator is assigned to each detector in the system. The level detectors are used to produce logic level outputs from the final analogue signals derived from the previous analogue processing stages. These logic outputs are fed into a specially designed priority interrupt encoder which is embedded into the CPLD. This enables the processor to be notified that a detector has been successfully impinged upon by the radiation and which detector it was. Industry standard, low power, high gain operational amplifiers are used to carry out this task.

Multiplexer 80

When an optical signal has impinged on a zone boundary of a multi zone target, a signal will be detected on more than one zone detector. The analogue to digital converter circuitry in the CPU is used to determine which zone has the dominant signal strength. The analogue multi channel multiplexer is driven by the encoder outputs from the CPLD so that the amplified analogue signals from the impinged zones are automatically presented to the ADC inputs. They are then sampled at high speed to determine which signal is dominant and therefore grade which target and zone is to be assigned the hit.

Target Signal Analysis, Processing, and Configuration Strategies

The signal processing strategy implemented is dependent on the type of optical detector technology used. However the electronic processing system of the target is designed to handle multiple signals simultaneously. In this example, up to 16 signals are available, although larger numbers can be easily handled due to the scalable architecture of the target system.

Typical detector configuration schemes can be up to 16 targets and up to 4 zones per target system, with a total limit of 16 for the product of targets and zones in a standard system. This means the number and arrangement of targets and zones is very flexible and is controlled by the embedded processor software.

When multiple detectors are used, the processing circuitry is capable of handling the detected signal using up to three simultaneous processing strategies to determine what the target score attributes are.

In the case of hit/miss detectors, the processing system determines on which detector the beam radiation from the shooting component 1 impinged, by sensing the electrical energy generated by the impinging radiation beam and then demodulating and decoding the signal data.

In the case of graded detectors, the processing system determines on which detector the beam radiation from the shooting component 1 impinged, by sensing the electrical energy generated by the impinge radiation beam. If more than one detector zone is involved because a zone boundary has been impinged, then an additional analogue and digital processing stage is used determine which detector is the major contributor whilst continuing to demodulate and decode the signals data.

In the case of precision scoring detectors, the processing system determines the position of impingement by viewing the luminance created on a translucent detector plate by the impinging beam using industry standard video camera technology inside a video chamber which excludes all ambient light.

The synchronous video output stream is processed by an analogue to digital converter circuit and the output is converted to Cartesian Co-ordinates and Polar Co-ordinate by the processor.

Target Apertures 52

A target aperture is an optically opaque barrier or plate with a precisely manufacture opening which allows the unimpeded transmission of light through the aperture. They are used to adjust to scoring area to different sizes when using fixed or oversized target detectors. It is much more economical to use a series of different sized apertures or an adjustable aperture, than it is the change the size of the detectors. Apertures can be made any size, shape or colour. Apertures can be used to provide flexibility to a fixed target design so it can be used for different shooting distances, shooting positions and different levels of precision if required.

Examples of some of the typical detector housings and target configurations are described in more detail below.

Detector Housing Designs

The housing 50 is designed to reduce the amount of ambient visible light impinging onto the detector to an absolute minimum via spectral filtering, electronic filtering, geometrical control and attenuation. This ensures that a high performance and reliable system is achieved which is able to reject all unwanted in band and out of band optical signals. This enables the detector to detect the radiation emitted by the shooting component which is of a low power to ensure user safety.

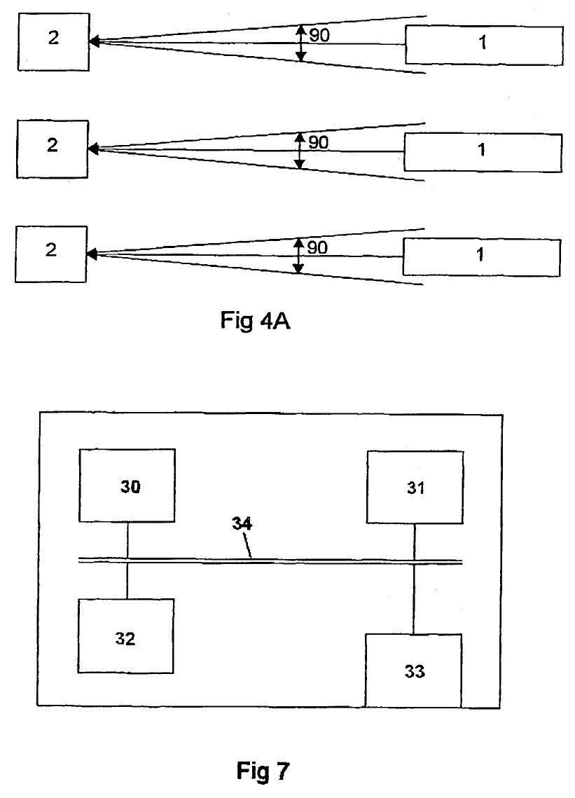

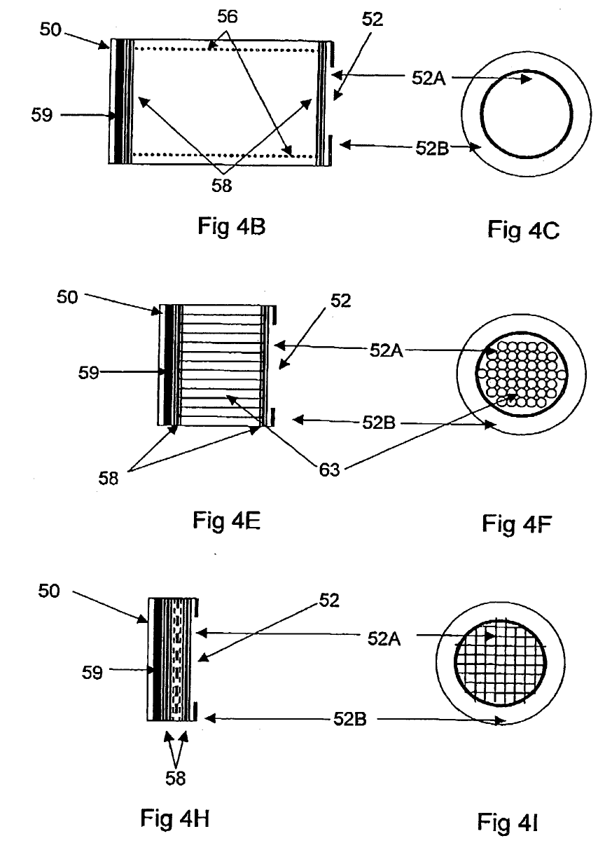

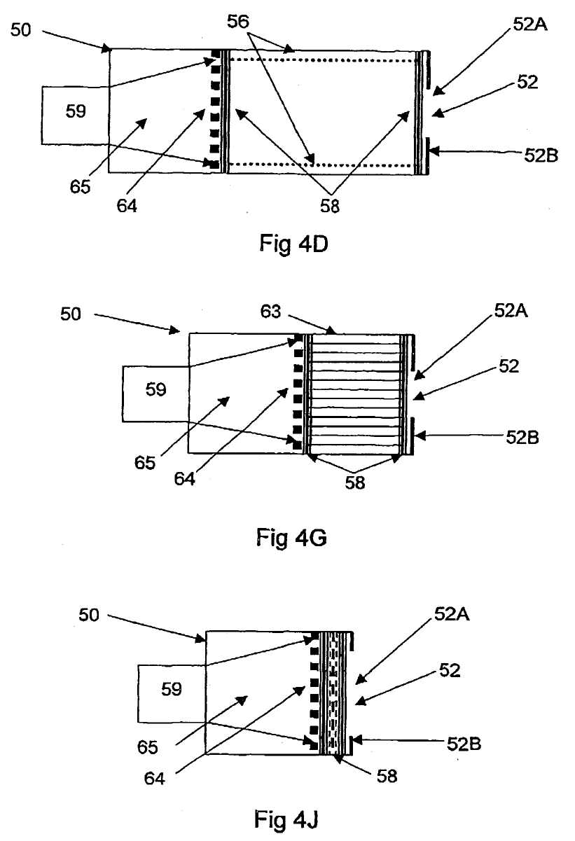

All the detector housing designs rely on the shooter being in a position which is on axis and in line with and perpendicular to the detector centre at a given distance. A degree of variation from the centre line by the shooter is possible and this degree of variation is called detector reception angle 90. This is shown in FIG. 4A.

The detector reception angle is controlled by the design of the detector housing 50. The housing is chosen to suit the desired shooting discipline. Generally the detector reception angle is determined by the ratio of the length and the cross sectional area of the cavities 55 or chamber used in the detector housing. These cavities may consist of one large single cavity, many mini cavities or many more micro cavities, depending on which design is chosen.

This is very useful for large shooting ranges where many shooting lanes are lined up side by side, with minimal separation. It also means that an increased density of shooting lane numbers can now be had for a given shooting range size and location, since the likelihood of an adjacent shooter accidentally scoring a hit on another shooters target can be eliminated by design.

If however, ambient light levels and density of shooting lanes are not important for a particular type of shooting style, the detector housing design can be made such that a greater degree of freedom is available for the shooting position relative to the centre line of the target.

Three detector housing designs have been developed to provide the above characteristics, namely:

1) Single Cavity design;

2) Multi Tunnel Grid design; and,

3) Multi Louvre Grid design.

Single Cavity Filter Housing

An example of the single filter housing for a hit or miss detector system is shown in FIGS. 4B and 4C, which are side and end schematic diagrams of the housing respectively.

As shown the housing 50 includes the cavity 55 with the entry 52 at one end and the detector 59 at the other. The band pass filter 58 is placed in directly in front of the detector 59, with a further band pass filter 58 being placed adjacent the aperture as shown. In this example, the rear of the housing 50 is sealed so no additional optical trap 60 is required.

As shown, the aperture 52 defines a hit area 52A and a miss area 52B. The hit area corresponds to the area which the radiation must hit whist traveling perpendicular to the plane of the aperture 52 in order to impinge on the detector 59.

An example of the single filter housing for a precision detector system is shown in FIG. 4D. In this example, the detector is formed from a CCD, CCTV detector. In order for this to function correctly, a translucent detector plate 64 and a dark video chamber 65 must be placed between the band pass filter 58 and the detector 59, as shown.

The cavity chamber and its cross section can be any geometrical shape such as circular, square, hexagonal etc. The internal wall of the chamber is covered with an optically absorbing and anti reflecting layer. The ratio of the cavity length to the cross-sectional area determines the angular optical rejection characteristics of the target. This approach provides an optical absorption and anti reflecting barrier to any non perpendicular light impinging on the target. This ensures that only in band light originating from the shooter reaches the detector.

This is the simplest in design, provides excellent attenuation of unwanted ambient light and also provides the ability to reject signals from adjacent shooting lanes via selection of suitable geometrical design parameters to control the detector reception angle. This housing design is economical to manufacture and particularly well suited to the hit miss detectors, which are unaffected by chamber depth if the size of the detector sufficiently exceeds that of the entry aperture.

Multi Tunnel Grid Filter Housing

An example of the multi tunnel grid filter housing for a hit or miss detector system is shown in FIGS. 4E and 4F, which are side and end schematic diagrams of the housing respectively.

As shown the cavity 55 is filled with a grid of hollow tubes 63 of a predefined length and cross sectional area which are typically of the order of a few millimetres in cross section size. The ratio of the hollow tube length and cross sectional area determines the angular optical rejection characteristics of the target.

This approach provides an optical absorption and anti reflecting barrier to any radiation which does nut pass through the aperture 52 in a direction perpendicular to the aperture plane. This ensures that only in band light originating from the shooter reaches the detector. Each hollow tube acts like small but independent cavity chamber and its cross section can be any geometrical shape such as circular, square, hormonal etc.

As a result of this, the length of the cavity can be significantly reduced compared to the cavity 55 used in the example of FIG. 4B.

An example of the multi tunnel grid filter housing for a precision hit detector system is shown in FIGS. 4G. Again, in this example, the detector is formed from a CCD CCTV detector.

This design is therefore reasonably compact due to the required of length of the overall chamber being independent of target size and only dependent on the cross sectional area size of the tubes used and the desired angular control from the shooting point.

Multi-Louvre Grid Filter Housing

An example of the multi-louvre grid filter housing for a hit or miss detector system is shown in FIGS. 4H and 4I, which are side and end schematic diagrams of the housing respectively.

In this example, the cavity 55 is filled with a grid of horizontal and vertical micro louvres of a predefined spacing and depth. The micro louvres are typically of the order of less than a millimetre in size. The ratio of the spacing and depth determines the angular optical rejection characteristics and therefore provides an optical absorption and anti reflecting barrier to any non-perpendicular light. This ensures that only in band light originating from the shooter reaches the detector. Each pair of horizontal and vertical louvres acts like small but independent cavity chamber.

An example of the multi-louvre grid filter horsing for a precision detector system is shown in FIG. 4J. Again, in this example, the detector is formed from a CCD CCTV detector.

This design is therefore very compact due to the required of length of the overall chamber being independent of target size but dependent on the cross sectional area size of the louvres used.

This housing design is particularly well suited to the multi zone and precision scoring detectors, which preferably utilise a very shallow chamber depth to perform accurately and minimise parallax error. This design is best where very compact target designs are required.

Hit Miss Target Configurations (Singe Zone Detectors)

Hit or Miss configurations utilise a single detector, forming a single target with only one hit zone. Although the detector size is fixed, the size of the scoring area can be reduced by placing an opaque aperture in front of the detector, thereby limiting the scoring zone.

By using more than one unit, a multi target system can be built and by mixing the type of opaque apertures used, a versatile configuration is possible. This scheme is able to form a very robust and economical target system since an additional optical control system can be placed in front of the detectors, with out affecting the scoring results.

Examples of some target system configurations will now be described. It will be realised that these are examples only and alternative arrangements could be used.

Single Target System

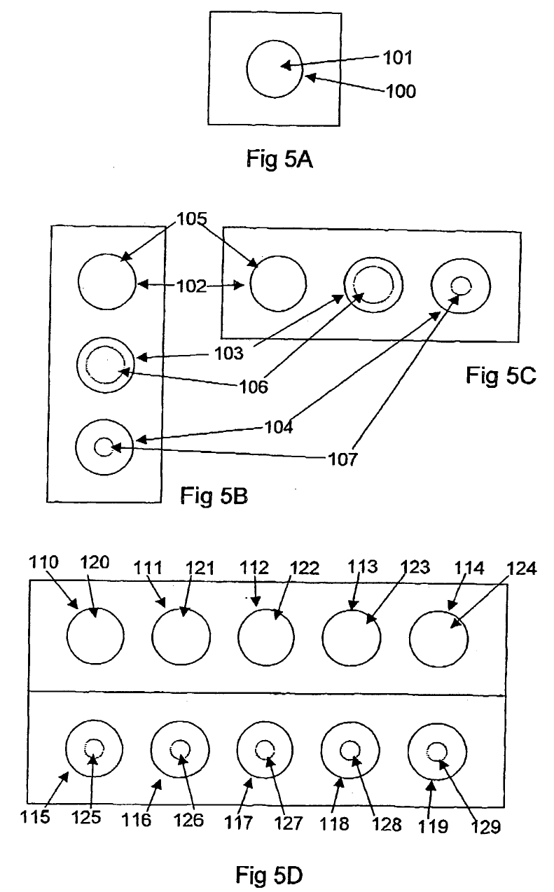

Consists of a single detector, forming a single target 100 with only one hit zone 101, as shown in FIG. 5A. A cost effective system for training, can be used in any format such as Standing, Kneeling or Prone shooting by fitting all appropriate opaque aperture.

Triple Target System

Consists of three individual signal detects 103, 104, 105, each forming a single target with only one hit zone 106, 107, 108. This system provides an array of three targets with similar or different scoring zone sizes depending on the aperture configurations used. Can be used in a vertical format shown in FIG. 5B, where for example, Standing, Kneeling and Prone shooting apertures would be used. Alternatively using similar apertures, the horizontal format shown in FIG. 5C helps replicate the process of moving from one target to another as in biathlon. This is a very cost effect trainer.

Dual Biathlon Target System

The dual biathlon target system shown in FIG. 5G consists of ten individual single detectors 110, 111, 112, 113, 114, 115, 116, 117, 118, 119, each forming a single target with only one hit zone 120, 121, 122, 123, 124, 125, 126, 127, 128, 129. This system provides two rows, each with an array of five targets with similar or different scoring zone sizes depending on the aperture configurations used. Typically used in winter biathlon events in the horizontal format for dual shooting position, depending on which aperture is used, where the shooter must move the point of aim to each target in the array with each shot fired.

Thus for example, triple or single Biathlon target systems can also be used.

Graded Target Configurations (Multi Zone Detectors)

This configuration utilises a single physical detector with multiple independent concentric detection zones forming a single target with more than one hit zone. The overall detector and individual detection zone sizes are fixed. Therefore, the size of the scoring zones is purposefully designed to suit multi position shooting at a particular shooting distance. By using more than one unit, a compact multi target system can be built whilst maintaining a versatile configuration. This scheme preferably uses an optical control system to be placed in front of the detectors, where parallax error will not affect the scoring results.

Examples of some target system configurations will now be described. It will be realised that these are examples only and alternative arrangements could be used.

Single Target Dual Zone Target System

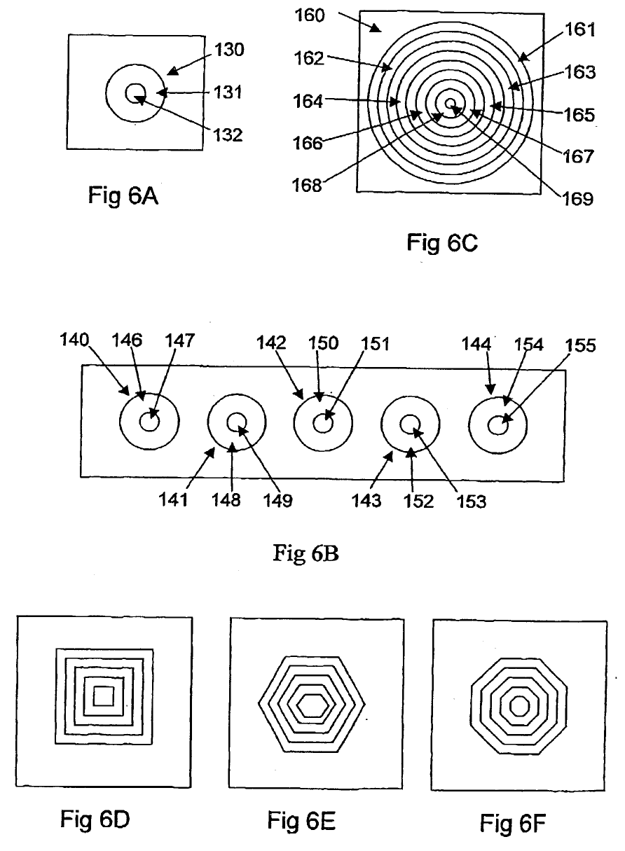

As shown in FIG. 6A, this design includes one individual dual zone detector 130 forming a single target with two concentric hit zones 131, 132. Typically used for cost effective winter biathlon dual shooting position training.

Biathlon Dual Zone Target System

The biathlon dual zone target system shown in FIG. 6B includes five individual dual zone detectors 140, 141, 142, 143, 144, 145, each forming a single target with two concentric hit zones 146, 147, 148, 149, 150, 151, 152, 153, 154, 155. The unit forms a target system of one very compact row consisting of an array of five targets. Typically used in winter biathlon events in the horizontal format for dual shooting position, where the shooter must move the point of aim to each target in the array with each shot fired.

Single Target Nine Zone Target System

As shown in FIG. 6C, any number of hit zones can be used however. Accordingly, in this example, the target system includes one individual ten zone detector 160, forming a single target with nine concentric hit zones 161, 162, 163, 164, 165, 166, 167, 168, 169. The unit forms a target system typically used in precision target shooting sports such as small bore and UIT format three position shooting competitions.

A number of alterative detector shapes are shown in FIGS. 6D, 6E and 6F. It will be appreciated that these or other shapes may be used in different detector configurations.

The Controller

An example of a controller is shown in FIG. 7. As shown the controller includes a processor 200, coupled to memory 201, an interface 202, and an input/output (I/O) device 203, via a bus 204.

In use, the I/O device typically includes a keyboard and mouse, to allow a user to enter data, together with a display or the like for providing information to the user. The memory 201 can be formed from a temporary memory such as RAM, or the like, or alternatively may be a permanent memory such as a hard disk. In this example the memory includes both temporary and permanent memory although for the purposes of simplicity, no distinction will be made in the following discussion.

Accordingly, it will be appreciated by a person skilled in the art that the processing system way be any one of a number of processing systems, such as a personal computer, a laptop, a PDA, a specialised terminal or the like.

In use, the processor 200 executes applications software stored in the memory 201. An example of the operational sequence flow of the controller when operating the applications software in the standard system is shown in Appendix C, with the operation of the enhanced system being shown in Appendix D.

The applications software causes the processor 200 to perform the following tasks, in an efficient and automated manner. This allows a small group of officials to run and manage a large event combining target shooting and physical activities. Events such as Biathlon traditionally have required a large number of officials due to safety and lack of integration of technologies. The software provides total integration of all aspects of the event by intimately interfacing with the other components of the system.

The tasks include:

1. Generate a target—lane number list and or file.

2. Generate a monitor—lane number list and or file.

3. Generate a competitor—bib number list and or file.

4. Set the starting time of the event.

5. Set the starting sequence for each competitor including mass start or staggered individual or staggered group modes of operation.

6. Display and record the starting times for each competitor.

7. Display and record the shooting lane number, entry & exit times, lane address number, bib number competitor number and shooting position as well as the target scores which can include hits on each target and total hits per zone during each shooting session for each competitor.

8. Display and record the competitor number, bib number, entry & exit times for main and penalty activity loops for each competitor.

9. Display and record the competitor number, bib number, starting & finishing time as well as additional information of each competitor such as first name, last name, gender, age group class, club and grade.

10. Generate an event and competitor time and score result file.

11. Configure software to communicate with multiple target systems.

Different versions of the applications software can be provided to handle different sizes of event, such as:

1. Small events with up to 5 shooting lanes and 50 competitors using a keyboard user interface.

2. Large events with up to 20 shooing lanes and 200 competitors with an advanced graphic based user interface as well as the standard keyboard interface.

3. Very large events with up to 100 shooting lanes and 1000 competitors. It has all the features of the previous software plus is capable of fully automated operation with special interface features to extract, competitor numbers, times and scores from the hardware in real time without user interaction.

Sequence Modes for Running an Event

The software is very automated and the keyboard and or graphical interface are very easy to use. To run an event you only need to perform a small number of functions for each competitor. This can be carried out using any one of three different modes. They are called the Mode, the Sequence Mode and the Automatic Mode. Which mode you use depends on how much hardware you have, what type it is and how you want to run your events.

Manual Mode

The Manual mode allows an event manager to control the sequence of events. Only the competitor starting sequence and gathering the scores from the targets are automatic functions. All other functions such as bib numbers, lane numbers as well as indicating when a competitor starts or finishes shooting sessions, main loops, penalty loops or finishes the event must be triggered by the event manager the I/O device. Although these functions are not automatic, they can still be performed quickly and easily via the software.

Although this mode requires the greatest interaction from the event manager, it is the most flexible mode and allows for any variations that may occur or you may want to implement in the sequence of an event. This can be used with both the standard and enhanced systems described in FIGS. 1A and 1B.

Sequence Mode

The Sequence mode uses the I/O device plus extra software parameters such as number of laps and shooting hits and misses so the software can control the sequence of events with only minimal user interaction. By selecting a predetermined sequence in software, the amount of interaction from the event manager is reduced to only providing the bib number and or lane number, while the software will count laps and indicated penalty laps.

Although this mode requires less interaction from the event manager, it is not as flexible as the manual mode and requires adherence to the predefined sequences of operation. This can also be used with both the standard and enhanced systems described in FIGS. 1A and 1B.

Automatic Mode

The Automatic mode uses extra hardware and software to identify each competitor and their position at the trigger points plus extra software parameters such as number of laps and shooting hits and misses so the software can control the sequence of events to completely automatic an event.

Although this mode requires basically no interaction from the event manager other than initialising the event operating conditions, it requires adherence to the predefined sequences of operation. This can only be used with the enhanced system described in FIG. 1B.

The Monitor Timing Component

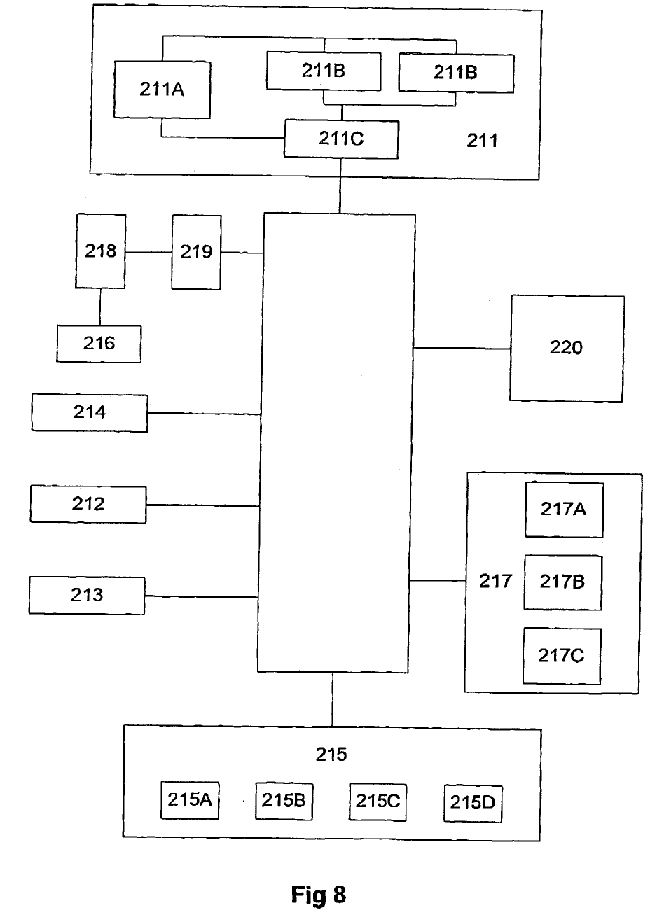

An example of the monitor timing component 4 is shown in FIG. 8. As shown the monitor timing component is formed from signal detection and processing circuitry that includes a processing system 210 formed from a processor 210A and programmable logic 210B. The processing system is coupled to a power supply 211, a mode selector 212, a menu selector 213, an athlete position detector 214, a number of interfaces 215, a number of indicators 217, and an Athlete & Equipment Identification Tag Interrogate 220, as shown.

In addition to this, the processor is also coupled to a detector and pre-amp 216, via a band pass filter and gain control 218, and a demodulator 219.

An example of the optional sequence flow of the monitoring timing component is shown in Appendix E.

The monitoring timing component 4 performs the following tasks:

1. Detect all coded/modulated hit and miss signals emitted from shooting component 1.

2. Reject all ambient and none coded/modulated signals impinging on the monitor timing component which did not originate from the shooting component 1.

3. Demodulate and decode received signals from shooting component 1.

4. Analyse and score all successfully demodulated and decode signals and calculate shooting statistics.

5. Provide error checked and analysed result information on shooting statics from the shooting component 1

6. Transmit error checking shooting statistics for both hit and misses data back to the data acquisition and control software.

7. Provide local visual and audible indication to the athlete of their shooting statistics in real time.

8. Detect the arrival and departure of an athlete at the shooting point or other predetermined positions.

9. Scan, detect, demodulate and decode signals to determine the identification of the athlete at the shooting point.

10. Transmit athlete position and identification data back to the data acquisition and control software.

The monitor carries out multiple tasks for enhancing the operation of both the shooting and scoring by providing the following functions.

In particular, the monitor timing component receives a duplicate set of data from the shooting component 1 each time a shot is fired. As the monitor timing component is positioned near the shooting component, it is extremely unlikely that the duplicate data would not be received thereby ensuing that reliable data communication can be achieved. This backup data transfer mechanism provides full redundancy during data transmission allowing full error detection and correction of information transferred during the shooting process.

The monitor timing component also collects and logs all timing and scoring information using data received from the shooting component, a detector and a high precision real time clock.

The monitor timing component also allows multiple target systems to be interconnected and controlled using a single controller. Controller access is provided via serial or Ethernet based connectivity, although text based or HTML web based data can be provided. Information can be transferred to a computer using either synchronized polling or asynchronous event driven modes of operation.

Another major role of the monitor timing component is to provide more sophisticated indication to the competitor of their results at close range since it is usually located in close proximity to the competitor for easy inspection. The monitor component is compact and portable, being small enough to be easily relocated by hand and battery powered for use in remote locations. It contains re pro programmable processor and complex programmable logic devices, to provide sophisticated and versatile capabilities. It carries out self-diagnostic tests and is designed to be highly reliable under extreme environmental conditions.

The housing is typically constructed from high impact, waterproof PVC, Poly Carbonate and Aluminium Alloy housing and contains a series of optical filters and optical block devices. Monitor housings are sealed against the environment to protect the internal electronic circuitry, detects and other components.

Signal Detection and Processing Circuits

The signal detection circuitry includes multiple stages of analogue processing including amplification, attenuation, filtering and level detection. Decoding, encoding and multiplexing of signals is carried out before presenting data to the processor interface.

The signal processing circuitry includes a processor and complex programmable logic device, based system with a number of sensor actuator options that is re programmable to allow customisation to suit specific target shooting requirements. The signal processing circuitry simultaneously receives and interrogates data from the shooting component and target systems in order to uniquely analyse and characterise the received information for processing into scored results.

Operation of each of the components of the monitor timing component system will now be described in more detail.

Power Supply 211

The power supply will be similar to that used by the shooting component 1 and the target system 2 and allows the system to operate from batteries or an external power supply. Accordingly, the power supply will not be described in any further detail.

Mode and Menu/Select Sensors 212 & 213

The mode and the menu and select sensors are similar to those described with respect to the shooting component 1 and these will therefore not be described in any further detail.

Indication Circuitry 217

The indicator circuitry includes audible piezoelectric and electromagnetic transducers 217A, visual light emitting diodes 217B and a visual multi-character alpha numeric liquid crystal display 217C. The indicators used are similar to those used by the shooting component 1 and accordingly, will not be described in detail.

In this case however, operational conditions include indication of successful normal run functions such as detecting that a target or zone has been successfully impinged on by a shooter.

Computer Interfaces 215

The target system uses interfaces including SPI, RS232, RS485 and IRDA interface connections 215A, 215B, 215C allowing half or full duplex data transfer to and from standard computers systems. This provides a means of extracting data from the system and or inserting data into the system, in order to read or modify system settings. The system can also be completely reprogrammed to provide new firmware upgrades as required.

When the RS485 or Ethernet & CAN 215D is used, multiple target systems can be connected to a single computer for supervisory data acquisition and control.

It will be appreciated that these interfaces are similar to those discussed above with respect to the shooting component 1 and the target system 2 and accordingly, these will not be discussed in any further detail.

Processor 210A

The processor 210A is similar to the processor 40A used in the shooting component and this will therefore not be discussed in any further detail.

The operation of the system is controlled by applications software executed by the processor.

Complex Programmable Logic 210B

The CPLD 210B is similar to the CPLD 40B used in the shooting component and this will therefore not be discussed in any further detail.

Detector and Preamplifier Array 216

The detectors are typically optoelectronic based detectors that are optimised for data transmission at short ranges. Accordingly, the detector is normally an industry standard, silicon photo-sensitive detector which converts photons into electrons.

The preamplifier array is used to amplify the very small signals received by the detectors to a level which will allow further processing by subsequent stages and minimise loading on the detectors by the following processing stages. Industry standard, low power, high gain operational amplifiers are used to carry out this task.

Band Pass Filter and Gain Control Array 218

This will be similar to the band pass filter and gain control array 78 used in the target system 2 and will not therefore be described in any further detail.

Demodulation and Level Detector Array 219

The demodulation and level detector array 219 is similar to the demodulation and level detector array 79 used in the target system and accordingly, will not be described in any further detail.

Athlete Position Detector 214

The purpose of the athlete position detector is to indicate that an athlete has reached a predefined position during an event such as the entry or exit of a shooing lane, beginning or end of a main loop and or penalty loop or has crossed the starting or finishing line. On receiving this signal, the motor timing component then begins an athlete and or equipment identification scan. If the monitor is situated at a shooting lane, it will also carry out an additional task and stand by to receive transmitted information from the shooting component 1 via divergent beam IEMR.

The position detector circuit can utilise a number of different sensors types which may include optical beam, ultrasonic or infra red motion detector, pressure sensor mat etc. The position detector sensor is always active and generates and external interrupt in the processor enabling the system to be normally shut down in low power energy saving sleep mode. Once the athlete is detected, the processor will wake up and begin processing all the necessary tasks until the athlete has departed.

This is an important input device because it is used the start all the tasks which result in a network interrupt being generated and subsequent information transfer to and from the controller.

Athlete & Equipment Identification Tag Interrogator 220

The purpose of the identification tag interrogator is to transmit and receive a signal from the interrogator in the local monitor timing component to and from shooting components 1 and/or athlete tags 44 that enter a zone and form a scanning network connection, as will be explained in more detail below.

The tag is described in more detail with respect to the shooting component 1.

Communication Networks that Interconnect the Components

The standard and enhanced systems are scalable systems that can include a number of shooting components and a number of target systems that are interconnected via communications networks.

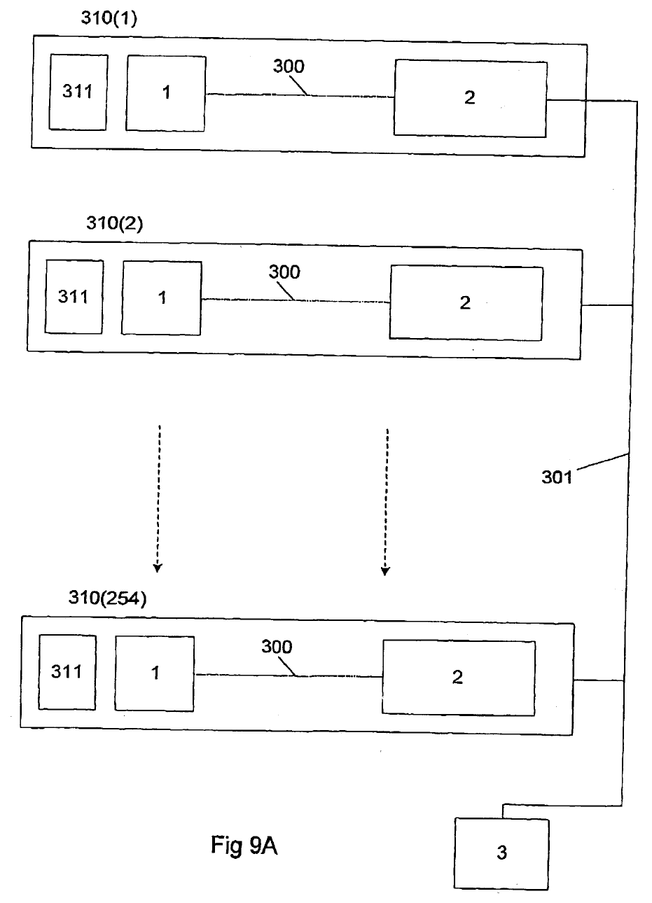

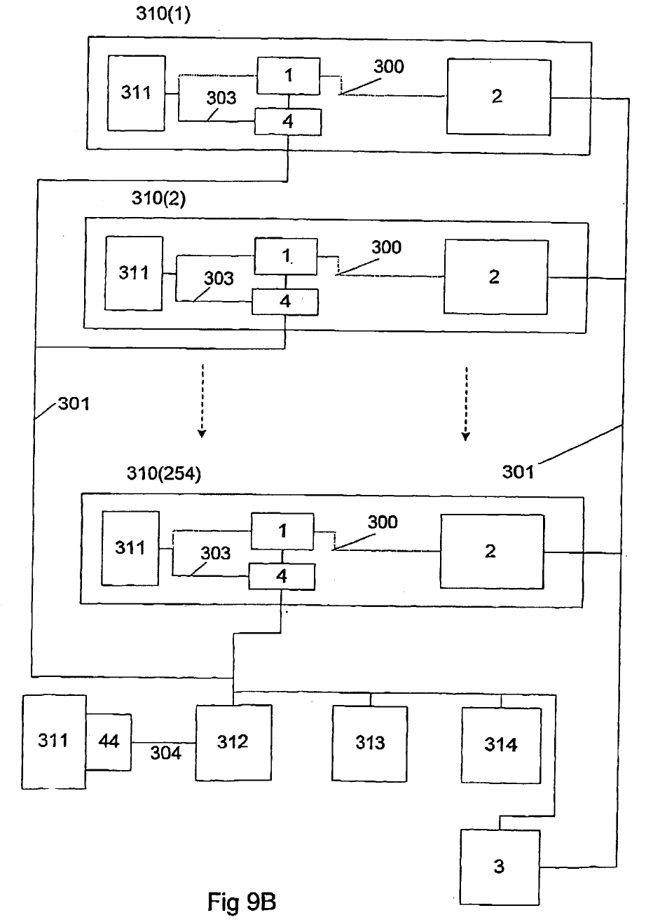

An example of a networked standard system is shown in FIG. 9A. As shown each shooting component 1 is associated with a respective target system 2 to form a respective shooting lane 310. In this example, up to 254 shooting lanes can be provided, allowing up to 254 athletes (each athlete being shown at 311) to shoot simultaneously.

The shooting component 1 and the respective target system 2 cooperate to form a shooting network 300, for each shooting lane 310. The target systems 2 are connected to a controller 3 via a data network 301.

An example of a networked enhanced system is shown in FIG. 9B. As shown in is example, each shooting lane 310 is provided with a local timing monitor 4 that is coupled to the respective athlete 311 and/or shooting component 1 via a scanning network 303. This is achieved either by having the monitor timing component 4 detect the identity tag 44 which either forms part of the shooting component, or which is coupled directly to the athlete as shown.

In addition to this, a main loop monitoring timing component 312, a penalty loop timing component 313 and a finish line timing component 314 can be provided or detecting the athletes 311 as they traverse a main loop and a penalty loop of a course. Again, the athletes are detected using the identity tag 44, which either forms part of a shooting component carried by the athlete, or is attached to the athlete directly, via a scanning network 304.

In either case, the carried either by detecting the main loop, penalty loop and finish line timing components 312, 313, 314 are coupled to the controller 4 and the monitoring timing components 4 via a data network 301.

Accordingly, at any one time, there can be up to four fully functional networks operating. They are the Shooting, Monitoring, Scanning and Data networks. Only the shooting and data networks are used in the Standard system configuration, whilst all four networks are required for the Enhanced system configuration.

A more detailed description of the networks will now be provided.

Shooting Network

The Shooting Network is a specialised wireless network between the shooting component 1 and the target. Its purpose is to simulate the target shooting and scoring process by transmitting data from the shooting component 1 to the target via a collimated pulse coded beam. The number of emitter nodes in the network can be determined by the number of competitors in the event which may be up to 1000 or more. The number of detector nodes in the network can be determined by the number of shooting lanes in the event which may be up to 254 or more depending on configuration.

Accordingly, the network consists of multiple independent point to point line on a common carrier between emitter and detector component pairs by utilising visible optical collimated beams for long range wireless transmission of data.

Although a network link can be composed of standard commonly available components its design is specialised and unique in order to achieved the desired operational characteristics. In some cases especially manufactured components can be used to further enhance the systems operation.

Some of the key features of a shooting network link are:

Reliably transmit data from the shooting device (emitter) to a remote target (detector).

Use a coded signal of visible electromagnetic radiation (VEMR) which is visible to the naked eye.

Simulate as closely as possible the act of shooting a projectile by using a controlled short pulse of VEMR with a fixed cross sectional area and fixed visible spot size.

Emit a power level of VEMR which will not damage or harm the human eye based on Australian and International Standards.

Detect a coded signal of VEMR in the presence of normal outdoor and indoor ambient light condition, including full mid day sunshine in highly reflective environments such snow fields at high altitude.

Detect the VEMR coded signal from a variety of distances from a few metres to several hundred metres.

Eliminate the likelihood of incorrect scoring by adjacent athletes that incorrectly shoot onto the wrong target.

Monitoring Network

The monitoring network is a specialised wireless network between the shooting component 1 and the monitor timing component 4. Its purpose is to enhance the target shooting and scoring process by transmitting data from the shooting component 1 to the monitor timing component via divergent pulse coded beam.

The number of shooting components in the network depends on the number of competitors in the event which may be up to 1000 or more, while the number of monitor timing components depends on the number of shooting lanes which may be up to 254. Therefore the network consists of multiple independent point to point links on a common carrier between emitter and monitor component pairs by utilising invisible optical divergent beams for short range transmission of data.

Some of the key features of a monitoring network link are:

Use a coded signal of invisible electromagnetic radiation (IEMR) which is invisible to the naked eye.

Complement the act of shooting a projectile by using a controlled short pulse of IEMR with a fixed cross sectional area invisible spot size which will impinge on the local monitor when the shooter either hits or misses the remote target.

The remaining key features are similar to the key features of the shooting network.

Scanning Network

The scanning network is a wireless network between the shooting components 1 and either or both of the athletes 311 and the monitor timing components 4. Its purpose is to track an athletes activities by transmitting data to and from the shooting component 1 and or athlete to the monitor timing component.

The number of shooting component and athlete nodes in the network depends on the number of competitors in the event and accordingly, can be 1000 or more. Therefore the network consists of multiple point to point wireless network links on a common carrier between many emitters and many monitors as well as many athletes and many monitors. This network utilises a radio frequency electromagnetic beam for short range omnidirectional transmission of data over a distance of a few metres.

Some of the key features of a monitoring network link are:

Reliably transmit data to and from a shooting device (tag) to a local monitor timing component (interrogator).

Reliably transmit data to and from an athletes wrist or ankle band (tag) to a local monitor timing component (interrogator).

Use a coded signal of electromagnetic radiation (EMR) to make a wireless link.

Emit a power level of EMR which will not damage or harm the human biology based on Australian and International Standards.

Detect a coded signal of EMR in the presence of normal outdoor and indoor ambient electromagnetic noise.

Detect the EMR coded signal from a variety if distances up to a few metres.

Eliminate the likelihood of incorrect scoring by adjacent athletes that incorrectly shoot on the wrong target.

Depending on the implementation, it is possible to combine the role of the monitor the scanning networks into one wireless system.

Data Network

The operation of the data network is based on any wired or wireless networking technology. Wireless technologies such as Bluetooth or the like, would be used for systems which are frequently relocated from location to location. For more permanent systems, wired technologies such as Ethernet or Token Ring networks, are more cost effective and reliable and even optical cable technology can be used for permanently locate systems.

Common wired networking technologies include Asynchronous RS485/RS422, Controller Area Network (CAN), Field Bus, World FIP Bus (uIP Bus) and Ethernet. The standard protocols such as TCP/IP can be used for those technologies such as Ethernet which support multi master networking, however for those that only support single master/multi slave environment then the following protocol methodology is used.

Some of the key features of the data network are:

Reliably transmit data to and from the controller, the target systems and the monitor timing component.

Allow multiple target systems and monitor timing components to connect to a single maser computer.

Provide a unique identification network address for each device on the network.

Data Network Transmission Protocol

Network nodes in the network consist of one master node formed by the controller 3 and many target system and monitor timing component nodes. The number of target system and monitor timing component nodes is determined by the number of shooting lanes set up for the event, which may be up to 254 of each depending on the configuration.

The system may also include up to three additional monitor timing component nodes for activity timing, on the main loop, the penalty loop and the finish line. Additional monitor timing components can be implemented, for example on the start line, if required.

Master Node

The controller 3 is the system master which normally functions in receive mode until software sequence flow control forces the controller to acquire data from a specific slave at which time it switches to transmit mode.

Slave Nodes

The target systems and the monitor timing components are always slaves and normally function in receive mode and switch to transmit mode when data is requested by the controller master. However they also have the ability to switch to transmit mode during a specific interrupt condition to notify the master that data is ready. This is controlled by the embedded applications software, as follows.

Interrupt conditions can be generated for example, every time an athlete starts and finishes a main or penalty loop, enters and exits a shooting lane, shoots at a target, scores a hit or crosses the finish line. These interrupt events may be combined so that a single interrupt is generated for example when the athlete enters a shooting lane and shoots at a target.

Thus, for example, when an athlete arrives at a shooting lane they are detected by the monitor timing component at which time they are scanned for identification information and their arrival times are stored. The athlete shoots at the target system, with the shots being simultaneously detected by the monitor tiring component 4. When the athlete leaves a shooting lane the monitor timing component 4 starts the interrupt and notification process by transmitting one short burst of data which includes the monitor timing components network address. This takes less than one millisecond, so the likelihood of collision is very low. This address will normally be received and accepted by the master controller 3 that will then request data from the component at that network address.

If the request from the controller 3 is received by the component, then it knows a successful interrupt and notification has taken place and acknowledges by sending the relevant data back to the controller after which the system returns back to receive mode. If a request from the controller is not received within a predetermine amount of time then the monitor timing component 4 knows that a collision or corruption has occurred and the interrupt and notification process starts again. Industry standard error detection and correction is used to ensure the received data is valid.

The controller 3 now knows that data is also ready to be collected form the target for that shooting lane which it then proceeds to get using the same process.

The target systems are always slaves and normally function in receive mode whilst storing relevant data. They will switch to transmit and forward mode when data is requested by the controller 3. This is because an athlete may enter a shooing lane and shoot at the target, but if every shot is a miss then no one would ever know. For this reason it is not normal to use these components in interrupt mode, but rely on store and forward after an external network request from the controller master.

The Monitor Timing components 4 used in shooting lanes are a multi-function component used for shooting, timing and scanning purposes. When an athlete enters a shooting lane, the shooting, scanning and entry timing functions will store relevant data as a slave in receive mode. However when an athlete exits a shooting lane a network interrupt notification will be generated. The controller will then request data from both the monitor timing and targets for that shooting lane and assemble all the necessary data into competitor record.

The Monitor Timing components 4 used in starting lines, main loops, penalty loops or finish lines are also used in the same way for collecting athlete timing and identification, however location data is provided instead of shooting and lane number information.

General

During major competitions, shooting equipment is scrutinised to ensure that the equipment meets the regulation criteria. With the above described system it is necessary to check features such as magazine capacities, beam collimation and spot sizes, identification code numbers etc. These features can be automatically tested by additional electronic and video imaging hardware.

In this case, each competitor would be required to set their equipment into the calibration mode of operation and fire a number of shots at the calibration target and monitor. The calibration target uses a precision scoring detector and this process records the equipment configuration settings which are transmitted with each calibration shot and records the beam spot size at the calibration distance. This procedure prevents cheating via tampering with equipment and can be applied before and after a competition if desired.

The system is designed to operate over large variations in temperature i.e. −20 to +60 degrees Celsius, as well as large variations in ambient light conditions. This means it will function in extreme conditions such as in high ambient light conditions encountered during mid day, mid summer or in snow fields with high reflectivity during full sunshine. Alteratively the system is designed to cope with extreme environmental factors such as rain and sleet or winter snow and blizzard conditions.

Accordingly, the above described target shooting systems utilise electronic technology to replicate the process of aiming and shooting at a target as in the general sport of target shooting but without the need for a conventional firearm.

The systems emulate all the features of shooting and scoring with the same precision as currently available with real firearms, but does not carry the same problems with safety. Accordingly, this allows events such as Biathlon to be held in public areas where firearms are normally excluded. Areas such as cycle ways, athletic parks and sports fields in metropolitan or suburban regions can be used. Environmentally sensitive wilderness areas such as snow fields and national wildlife parks can also be used with no impact. Furthermore participants of any age can use the system without safety concerns.

In addition to this, the enhanced system can gather athlete timing and identification information whilst an athlete is participating in a physical activity, such as snow skiing, roller skiing, roller blading, running, cycling, mountain bike riding, wheel chair racing, horse riding, or any other physically demanding activity.

It will be appreciated by persons skilled in the art that numerous variations and modifications will become apparent. All such variations and modifications which become apparent to persons skilled in the art, should be considered to fall within the spirit and scope of the invention as broadly hereinbefore described.

[image]

[image]

[image]

[image]

[image]

[image]

[image]

[image]

[image]

[image]

[image]

[image]

[image]

[image]

[image]

[image]

1) A controller adapted to control a target shooting system for use in an event, the target shooting system including shooting components adapted to simulate shots by emitting radiation having a predetermined frequency, and one or more target systems, each target system being adapted to determine a hit if the radiation impinges on the detector, and determine score data based on the number of hits for a predetermined number of shots, the controller including:
a) A communications port for communication with the target system(s) via a communications network;
b) A display;
c) A processor, the processor being adapted to:
i) Receive identity data representing the identity of individuals competing in the event;
ii) Receive timing data representing the time taken by each individual in shooting and/or traversing a course including one or more circuits.
iii) Obtain at least the score data from the targets,
iv) Determine results of the event based on the score data, the timing data and the identity data; and,
v) Display the results on the display;

2) A controller according to claim 1, the processor being further adapted to generate a starting sequence, the starting sequence being used by the user to start the event.

3) A controller according to claim 1 or claim 2, the controller further including an input for manually inputting data.

4) A controller according to claim 3, the processor being further adapted to operate in a manual mode in which the identity data and the timing data is received via the input.

5) A controller according to claim 4, when the controller is coupled to more than one target system, the processor being adapted to receive target data via the input, the target data representing the target system used by each individual, the processor being adapted to determine the results based on the target data.

6) A controller according to claim 3, the controller being coupled to a number of sensors for detecting the individuals as they shoot or traverse the course, the processor being adapted to receive the identity data and the timing data via the sensors.

7) A controller according to claim 6, wherein in use, each individual is associated with an identifier having an identifier store storing the identity data for the individual, the sensors being adapted to communicate wirelessly with the identifier to obtain the identity data.

8) A controller according to claim 6 or claim 7, when the controller is coupled to more than one target system a respective sensor is associated with each target system, the processor being further adapted to receive target data representing the target system used by each individual, the processor being adapted to determine the result based on the target data.

9) A controller according to any of claims 3 to 8, wherein event data indicating a number of laps is received via the input, and wherein the score data indicates the number of hits and misses by each individual, the processor being further adapted to generate an event sequence for controlling the event in accordance with the event data and the score data.

10) A controller adapted to control a target shooting system for use in an event, the target shooting system including shooting components adapted to simulate shots by emitting radiation having a predetermined frequency, and one or more target systems, each target system being adapted to determine a hit if the radiation impinges on the detector, and determine score data based on the number of hits for a predetermined number of shots, the controller being substantially as hereinbefore described with reference to any of the accompanying drawings.

11) A computer program product adapted to control a target shooting system for use in an event, the target shooting system including shooting components adapted to simulate shots by emitting radiation having a predetermined frequency, and one or more target systems, each target system being adapted to determine a hit if the radiation impinges on the detector, and determine score data based on the number of hits for a predetermined number of shots, the computer program product including computer executable code which when run on a processor causes the processor to:
a) Receive identity data representing the identity of individuals competing in the event;
b) Receive timing data representing the time taken by each individual in shooting and/or traversing a course including one or more circuits.
c) Obtain at least the score data from the targets,
d) Determine results of the event based on the score data, the timing data and the identity data; and,
e) Display the results on the display;

12) A computer program product according to claim 11, the computer program being further adapted to generate a starting sequence, the starting sequence being used by the user to start the event.

13) A computer program product according to claim 12, the computer program product being further adapted to cause the processor to operate in a manual mode in which the identity data and the timing data is received via a manual input.

14) A computer program product according to claim 13, when the processor is coupled to more than one target system, the computer program product being adapted to cause the processor to receive target data via the input, the target data representing the target system used by each individual, the processor being adapted to determine the result based on the target data.

15) A computer program product according to claim 12, the processor being coupled to a number of sensors for detecting the individuals as they shoot or traverse the course, the computer program product causing the processor to receive the identity data and the timing data via the sensors.

16) A computer program product according to claim 13, wherein, when the processor controller is coupled to more than one target system, a respective sensor is associated with each target system, the computer program product causing the processor to receive target data representing the target system used by each individual, the processor being adapted to determine the result based on the target data.

17) A computer program product according to any of claims 10 to 16, the score data further indicating the number of hits and misses by each individual, the computer program product input causing the processor to receive event data indicating the number of laps via the input, and to generate an event sequence for controlling the event in accordance with the event data and the score data.

18) A computer program product substantially as hereinbefore described with reference to any of the accompanying drawings.

19) A shooting component for use in a target shooting system, the target shooting system including at least one target for detecting radiation emitted by the shooting component, the shooting component including:
a) A housing;
b) A trigger mounted to the housing;
c) A radiation source for generating collimated radiation having a predetermined frequency;
d) A store for storing shot data indicating a number of shots available;
e) A processing system coupled to the trigger, the processing system being adapted to:
i) Determine the number of shots available from the shot data;
ii) If one or more shots are available, monitor the trigger;
iii) In response to operation of the trigger, cause the radiation source to generate at least a pulse of radiation; and,
iv) Modify the shot data to reduce the number of shots available.

20) A shooting component according to claim 19, the radiation source being adapted to generate visible radiation.

21) A shooting component according to claim 19 or claim 20, the shooting component further including a trigger detector, the trigger detector being mounted to the housing to detect movement of the trigger and the processing system being coupled to the trigger detector to detect operation of the trigger.

22) A shooting component according to any of claims 19 to 21, the shooting component further including an action mounted to the housing to simulate the loading of a firearm, the processing system being further adapted to:
i) If one or more shots are available, monitor the action; and,
ii) In response to operation of the action, monitor the trigger.

23) A shooting component according to claim 22, the shooting component further including an action detector, the action detector being mounted to the housing to detect movement of the action and the processing system being coupled to the action detector to detect operation of the action.

24) A shooting component according to any of claims 19 to 24, the housing including:
a) A stock adapted to be held by the user in use, the trigger being coupled to the stock;
b) A tubular barrel defining a barrel axis, the barrel having a first end mounted to the stock, the radiation source being mounted in the first end of the barrel so as to emit radiation pulses from a second end of the barrel in a direction substantially parallel to the barrel axis;
c) Sights mounted to the barrel to align the barrel with the target; and,
d) A chassis coupled to the stock, the processing system being mounted on the chassis

25) A shooting component according to claim 24, the stock including:
a) A cheek piece;
b) A butt piece;
c) A fore hand grip; and,
d) A trigger grip.

26) A shooting component according to any of claims 19 to 25, the store being adapted to store identity data, the identity data representing the respective shooting component or the individual using the shooting component, the shooting component being adapted to transmit the identity data to the target.

27) A shooting component in accordance with claim 26, the processing system being adapted to pulse modulate the radiation in accordance with the identity data, thereby transmitting the identity data to the target.

28) A shooting component according to any of claims 19 to 27, the shooting component further including a display coupled to the processing system, the display being adapted to display the shot data.

29) A shooting component according to any of claims 19 to 28, the shooting component further including a magazine adapted to couple to the housing in use, the magazine including the store and a connector for coupling the store to the processing system.

30) A shooting component according to any of claims 19 to 29, the shooting component including a second radiation source coupled to the processing system, the second radiation source being adapted to generate divergent radiation having a second predetermined frequency, the target being adapted to detect the divergent radiation to determine when a shot has been fired.

31) A shooting component according to claim 30, the second radiation source generating non-visible radiation.

32) A shooting component according to claim 30 or claim 31, when dependent on at least claim 26, the processing system being adapted to pulse modulate the divergent radiation in accordance with the identity data, thereby transmitting the identity data to the target.

33) A shooting component for use in a target shooting system, the target shooting system including at least one target for detecting radiation emitted by the shooting component, the shooting component being substantially as hereinbefore described with reference to the accompanying drawings.

34) A target system for use in a target shooting system, the target shooting system including a shooting component adapted to simulate shots by emitting of radiation having a predetermined frequency, the target including:
a) A target housing;
b) One or more targets, each target including at least one detector;
c) One or more filters for filtering radiation impinging on each detector, each filter being adapted to transmit radiation having the predetermined frequency and each filter including:
i) A geometrical filter; and
ii) An optical filter; and,
d) A detection system adapted to:
i) Determine a hit to occur by detecting radiation impinging on a detector; and,
ii) Determine a score based on the number of hits for a predetermined number of shots.

35) A target system according to claim 34, each geometrical filter including a cavity, the cavity having an aperture defining an aperture plane mounted at a first end of the cavity, the detector being mounted at a second opposing end of the cavity such that only radiation entering the aperture substantially perpendicular to the plane impinges on the detector.

36) A target system according to claim 35, the inner surface of the cavity being coated with a radiation absorbing surface.

37) A target system according to claim 35 or claim 36, the cavity including a number of tubes, each of which extends from the aperture to the detector, the inner surface of each tube being coated with a radiation absorbing surface.

38) A target system according to claim 35 or claim 36, the cavity including a number of micro louvres extending from the aperture to the detector.

39) A target system according to any of claims 34 to 38, the optical filter including a band pass filter, the band pass filter being adapted to transmit radiation having the predetermined frequency.

40) A target system according to any of claims 34 to 39, the shooting component being adapted to pulse modulate the radiation in accordance with identity data, the identity data representing the respective shooting component or the individual using the shooting component, the detection system being adapted to detect the pulse modulation of the radiation to determine the identity data.

41) A target system according to any of claims 34 to 40, the shooting component being adapted to generate divergent radiation, the target system including at least one second detector coupled to the detection system, the second detector being positioned remotely to the target housing to allow the detection system to detect the divergent radiation to determine when a shot has been fired.

42) A target system according to claim 41, the shooting component being adapted to pulse modulate the divergent radiation in accordance with identity data, the identity data representing the respective shooting component or the individual using the shooting component, the detection system being adapted to detect the pulse modulation of the divergent radiation to determine the identity data.

43) A target system according to claim 41 or claim 42, the second detector being adapted to detect non-visible radiation.

44) A target system according to any of claims 34 to 43, at least one detector being divided into a number of zone, the detection system being adapted to determine a score in use, the score indicating the number of times the radiation has impinged on different detector zones, each zone being assigned a respective score.

45) A target system according to claim 44, the target system further including a target display, the target display being adapted to display an indication of the current score in use.

46) A target system for use in a target shooting system, the target shooting system including a shooting component for emitting radiation having a predetermined frequency, the target system being substantially as hereinbefore described with reference to the accompanying drawings.

47) A target shooting system adapted for use in an event, including:
a) One or more shooting components adapted to simulate shots by emitting radiation having a predetermined frequency;
b) One or more target systems, each target system being adapted to determine a hit if the radiation impinges on a detector, and determine score data based on the number of hits for a predetermined number of shots; and,
c) A communications network; and,
d) A controller adapted to:
i) Receive identity data representing the identity of individuals competing in the event;
ii) Receive timing data representing the time taken by each individual in shooting and/or traversing a course including one or more circuits.
iii) Obtain at least the score data from the targets; and,
iv) Generate results of the event based on the score data, the timing data and the identity data.

48) A target shooting system according to claim 47, the target shooting system including a shooting component according to any of claims 19 to 33.

49) A target shooting system according to claim 47 or claim 48, the target shooting system including a controller according to any of claims 1 to 10.

50) A target shooting system according to any of claims 47 to 49, the target shooting system including a target system according to any of claims 34 to 46.

51) A target shooting system according to any of claims 47 to 50, the target shooting system further including:
a) An identifier associated with each individual, the identifier including a store for storing the identity data of the individual; and,
b) A number of sensors, at least one sensor being associated with each target system, the sensors being adapted to:
i) Detect the individuals as they shoot or traverse the course;
ii) Communicate wirelessly with the identifiers to obtain the identity data; and,
iii) Generate the timing data, the timing data being transferred to the controller.

52) A target shooting system according to claim 51, when dependent on claims 50 and 41, each second detector being associated with a respective sensor, the sensor and the second detector being positioned remotely to the target housing near the shooting component in use.

53) A target system according to claim 52, each second detector being a respective sensor.

54) A target shooting system according to any of claims 47 to 53, the target shooting system being adapted for use in a biathlon event.

55) A target shooting system adapted for use in an event substantially as hereinbefore described with reference to the accompanying drawings.
